(19) United States
(12) Patent Application Publication
(10) Pub. No.: US 2006/0159010 A1
(43) Pub. Date: Jul. 20, 2006

(54) Information processing system, information processing device, and information processing method and program therefor

(75) Inventors: Ichirou Yamaguchi, Tokyo (JP); Hideyuki Shimonishi, Tokyo (JP); Yohei Hasegawa, Tokyo (JP); Takayuki Hama, Tokyo (JP); Tutomu Murase, Tokyo (JP); Akira Arutaki, Tokyo (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(73) Assignee: NEC Corporation

(21) Appl. No.: 11/334,627

(22) Filed: Jan. 19, 2006

(30) Foreign Application Priority Data
Jan. 19, 2005 (JP) 011021/2005
May 11, 2005 (JP) 137956/2005

(51) Int. Cl. H04L 12/26

(52) U.S. Cl. 370/216

(57) ABSTRACT

An information processing system operated by an active system and a standby system can reduce the load of a status synchronizing process. In a pair of an active information processing device and a standby information processing device closest to a transmitting terminal in the information processing system, the standby information processing device is arranged closer to the transmitting terminal. In a pair of an active information processing device and a standby information processing device closest to a receiving terminal in the information processing system, the standby information processing device is arranged closer to the receiving terminal. In other pair, a standby information processing device can be arranged closer to either the transmitting terminal or the receiving terminal.

### BACKGROUND OF THE INVENTION

1. Field of the Invention

The present invention relates to an information processing system, an information processing device, and an information processing method and a program for use with them, and more specifically to a method for protecting a communication device against a fault to enhance the resistance against a fault occurring in any component forming an information processing system.

2. Related Art

Conventionally, a faulty device is separated and a redundancy device is used as a countermeasure against a fault of a communication device. For example, a bypass is prepared in a device, and when a fault occurs, control is switched to the bypass and communications are performed (for example, refer to “Packet Shaper Technological Information: Bypass Capabilities as Countermeasures against Fault/Fail-over Management Capabilities” (2004 Macnica Network Corp.), http://www.macnica.net/packeteer/packetshp_tech_{—}05.html). A method of configuring a redundant device can be connecting two devices in parallel to operate the respective devices as an active system and a standby system (for example, refer to “High Availability Fire Wall” (by Yoshitane Tachibana, Oki Technical Review, Oki Electric Industry Co., Ltd., July, 2000, vol. 67, issue 183, No. 2, pages 103-106), http://www.oki.com/jp/Home/JIS/Books/KENKAI/n183/pdf/183R24.pdf). In this method, when a fault occurs in the active system, control is switched to the standby system and communications are performed.

Especially, when a communication device manages the status of the communication performed between the transmission/reception terminals and transmits a received acknowledgment to a transmitter like a SOCKS server, it is necessary to keep synchronization between the active system and the standby system (for example, refer to M. Leech, M. Ganis, Y. Lee, R. Kuris, D. Koblas, L. Jones, “SOCKS Protocol Version 5,” Internet Engineering Task Force, RFC1928, March 1996). The “status” refers to which portion of data has been transmitted and received between the terminals.

FIG. 31 shows an example of the above-mentioned redundant device. In FIG. 31, a switch (SW) 6 is connected to the input terminals of an active information processing device 7 and a standby information processing device 8, and a switch 9 is connected to their output terminals. Using these switches 6 and 9, the active system and the standby system are switched. That is, the switch 6 outputs input data to each of the active information processing device 7 and the standby information processing device 8. Of the data from the active information processing device 7 and the standby information processing device 8, the switch 9 outputs the data from the active information processing device 7 to the next stage.

The active information processing device 7 and the standby information processing device 8 respectively includes data processing units 71 and 81, buffer units 72 and 82, discard control units 73 and 83, operation status monitoring units 74 and 84, output selection units 75 and 85, and status synchronizing process units 76 and 86.

The data processing units 71 and 81 perform a process for communication with another device not shown in the attached drawings to process the data input by the switch 6, and output the processed data to the buffer units 72 and 82. The buffer units 72 and 82 accumulate the data from the data processing units 71 and 81, output the accumulation status to the status synchronizing process units 76 and 86, discard the accumulated data under the control of the discard control units 73 and 83, and output the accumulated data to the output selection units 75 and 85.

The discard control units 73 and 83 transmit an instruction to discard data to the buffer units 72 and 82 when, for example, data is accumulated to the full capacity of the buffer units 72 and 82. The operation status monitoring units 74 and 84 monitor whether or not the information processing device including the operation status monitoring unit is operating as an active system or a standby system, transmit a monitor result to the output selection units 75 and 85, and transmit the monitor result to the operation status monitoring units 84 and 74 of each other.

When the monitor result as an active system is input from the operation status monitoring units 74 and 84, the output selection units 75 and 85 output the data from the buffer units 72 and 82 to the switch 9. When the monitor result as a standby system is input, the output of the data from the buffer units 72 and 82 to the switch 9 is suppressed. The status synchronizing process units 76 and 86 mutually compare the accumulation statuses from the buffer units 72 and 82, and mutually perform a synchronizing process (copying and accumulating data) such that the accumulation statuses of the buffer units 72 and 82 can be the same.

FIG. 32 shows the synchronizing process between the active information processing device 7 and the standby information processing device 8. In FIG. 32, if a packet is lost (packet data “8” is lost) during the data transmission to the standby information processing device 8 when packet data “5”, “6”, “7”, and “8” are being accumulated in the buffer unit 72 of the active information processing device 7, the statuses of the packet data accumulated in the buffer units 72 and 82 do not match.

To remove the nonmatching statuses, an explicit synchronizing process is performed between the status synchronizing process units 76 and 86. In this synchronizing process, the packet data “8” in the buffer unit 72 is copied by the status synchronizing process units 76 and 86, the copied data is transferred to the buffer unit 82 and accumulated there. Therefore, the nonmatching statuses of the packet data accumulated in the buffer units 72 and 82 can be removed.

The reason why the synchronizing process is required in forming a redundant device is that a communication disconnection occurs if the system is switched to the standby system with nonmatching statuses between the active system and the standby system maintained. Since the device returns acknowledgment upon receipt of data transmitted from a transmitter, the data is discarded if the transmitter receives the acknowledgment. If a fault occurs in the active system before transmitting data corresponding to the acknowledgment, only the standby system can recover the data. Furthermore, if the system is switched to the standby system with nonmatching statuses maintained when a fault occurs in the active system, then problem of the nonmatching statuses between the transmitting and receiving terminals cannot be solved, thereby causing a communication disconnection.

Therefore, when the above-mentioned redundant device is formed, it is necessary to keep synchronization of statuses between the active system and the standby system. However, the synchronizing process is to be performed for each piece of received data, which causes a overload status of a device, reduces communication performance, and causes a communication disconnection when a fault occurs in the active system with the nonmatching statuses of the active system and the standby system maintained depending on the timing of the synchronizing process and the system is switched to the standby system.

In the above-mentioned conventional countermeasure against a fault of a communication device, when there is an increasing number of sessions managed by an information processing device, there also is an increasing amount of managed information, and the load of the status synchronizing process between an active system and a standby system, that is, the load of confirming matching statuses of data accumulated in the buffer, copying data when the statuses do not match, and accumulating the data in the buffer, increases. Therefore, the status synchronizing process is performed, thereby causing the problem of reducing the communication efficiency, throughput, and communication performance.

Furthermore, in the conventional countermeasure against a fault of a communication device, if an information processing device terminates the communication session between transmitting and receiving terminals for takeover, and if the process of the active system is taken over by the standby system with data received by the active system but not received by the standby system (refer to FIG. 32), then the data which cannot be received cannot be recovered, and the nonmatching communication statuses between the transmitting and receiving terminals cannot be recovered, thereby causing the problem of a communication disconnection occurring by the nonmatching statuses between the active system and the standby system.

In the status in which there is data which cannot be received by a standby system (refer to FIG. 32) in the conventional countermeasure against a fault in a communication device, when a system is switched from the active system to the standby system, timing is to be taken into account if a TCP (transmission control protocol) is used in a transport layer in the communications between the transmission and reception terminals, thereby causing the problem of reducing the communication performance by the nonmatching statuses between the active system and the standby system.

### BRIEF SUMMARY OF THE INVENTION

The objective of the present invention is to provide an information processing system, an information processing device, and a information processing method and a program for the system and the device to solve the above-mentioned problems and reduce the load of the status synchronizing process in the information processing system operated by an active system and a standby system.

Another objective of the present invention is to provide an information processing system, an information processing device, and an information processing method and a program for the system and the device to allow a standby system to hold the status of an active system.

A further objective of the present invention is to provide an information processing system, an information processing device, and an information processing method and a program for the system and the device to effectively use a buffer for accumulating data for use in case of a fault of an adjacent information processing device.

An information processing system according to the present invention has a redundant configuration by operating a plurality of information processing devices. The information processing device includes: operation status monitor means for monitoring operation statuses of the device and another device; input means for receiving data; buffer means for temporarily accumulating the data from the input means; and output selection means for selecting and outputting one of the data accumulated in the buffer means and the data directly input from the input means in accordance with the operation statuses of the device and the other device to be monitored by the operation status monitor means; and the plurality of information processing devices are connected in series.

Another information processing system according to the present invention has a redundant configuration by operating a plurality of information processing devices as an active system and a standby system. The information processing device includes means for passing input data through to a subsequent stage when the device is operated as the standby system, and an information processing device operated as the standby system is arranged before an information processing device as the active system, and the devices are connected in series.

The information processing device further includes discard control means for discarding the input data accumulated in buffer means when the device is operated as the standby system.

An information processing device according to the present invention forms a redundant system by an operation with a plurality of information processing devices, and includes: operation status monitor means for monitoring operation statuses of the device and another device; input means for receiving data; buffer means for temporarily accumulating the data from the input means; and output selection means for selecting and outputting one of the data accumulated in the buffer means and the data directly input from the input means in accordance with the operation statuses of the device and the other device to be monitored by the operation status monitor means. The device is connected in series with each of the plurality of information processing devices.

Another information processing device according to the present invention forms a redundant system by an operation as one of an active system and a standby system, and includes: means for passing input data through to a subsequent stage when the device is operated as the standby system. The information processing device is arranged before an information processing device operated as the active system when the device is operated as the standby system, and connected in series with the information processing device operated as the active system.

The information processing device according to the present invention further includes discard control means for discarding the input data accumulated in buffer means when the device is operated as the standby system.

An information processing method according to the present invention is used for an information processing system having a redundant configuration by operating a plurality of information processing devices. The information processing device monitors operation statuses of the device and another device, receives data by input means for receiving data, and selects and outputs one of data accumulated in buffer means for temporarily accumulating the data from the input means and the data directly input from the input means in accordance with the operation statuses of the device and the other device to be monitored. The plurality of information processing devices are connected in series.

An information processing method according to the present invention is used for an information processing system having a redundant configuration by operating a plurality of information processing devices as an active system and a standby system. The information processing device performs a process of passing input data through to a subsequent stage when the device is operated as the standby system, an information processing device operated as the standby system is arranged before an information processing device as the active system, and the devices are connected in series.

In the information processing method according to the present invention, the information processing device performs a process of discarding the input data accumulated in buffer means when the device is operated as the standby system.

A program for an information processing method according to the present invention is used for an information processing system having a redundant configuration by operating a plurality of information processing devices. The program directs the computer of the information processing device to perform the processes of: monitoring operation statuses of the device and another device; receiving data by input means; and selecting and outputting one of data accumulated in buffer means for temporarily accumulating the data from the input means and the data directly input from the input means in accordance with the operation statuses of the device and the other device to be monitored. The plurality of information processing devices are connected in series.

Another program for an information processing method according to the present invention is used for an information processing method for use with an information processing system having a redundant configuration by operating a plurality of information processing devices as an active system and a standby system. The program directs the computer of the information processing device to perform the process of passing input data through to a subsequent stage when the device is operated as the standby system, and the information processing device operated as the standby system is arranged before the information processing device operated as the active system, and the devices are connected in series.

The program for the information processing method according to the present invention directs the computer of the information processing device to perform a process of discarding the input data accumulated in buffer means when the device is operated as the standby system.

That is, in the first information processing system according to the present invention, a standby information processing device is arranged at the stage before an active information processing device, and the devices are connected in series. The standby information processing device includes means for processing and accumulating data from input means for receiving the data, and means for selecting whether the accumulated data is output or the data directly input from the input means is output. In the first information processing system according to the present invention, the standby information processing device holds input data and passes the input data through to the active information processing device, thereby maintaining the same statuses in the active information processing device and the standby information processing device, and requiring no explicit status synchronizing process. Therefore, the first information processing system according to the present invention can solve the above-mentioned problems.

In addition to the configuration of the first information processing system, the second information processing system according to the present invention further includes, in the standby system, discard control means for discarding the data accumulated in the buffer. With the configuration, the second information processing system according to the present invention can realize the use of a buffer which is a finite resource, thereby solving the above-mentioned problems.

In the first information processing system according to the present invention, the standby information processing device is arranged at a stage before the active information processing device with the devices connected in series. Thus, holding input data by the standby information processing device allows the standby information processing device to be synchronized with the active information processing device, thereby reducing the load of the status synchronizing process. Since the data input to the active information processing device is constantly output by the standby information processing device, an explicit status synchronizing process, that is, the process of confirming the matching status of the data accumulated in the buffer, copying the data when a nonmatching status is detected, or accumulating the data in the buffer, etc., is not required.

In the second information processing system according to the present invention, the data input to the active information processing device is constantly output by the standby information processing device by connecting the standby information processing device at the stage before the active information processing device in series, thereby allowing the standby information processing device to constantly hold the status of the active information processing device.

### BRIEF DESCRIPTION OF THE DRAWINGS

FIG. 1 is a block diagram of the configuration of the information processing system according to an embodiment of the present invention;

FIG. 2 is a block diagram of the configuration of the information processing device according to a first example of the present invention;

FIG. 3 is a flowchart of the operation status monitoring process according to the first example of the present invention;

FIG. 4 is a flowchart of the operating process according to the first example of the present invention;

FIG. 5 is a flowchart of the operating process according to the first example of the present invention;

FIG. 6 is a flowchart of the operating process according to the first example of the present invention;

FIG. 7 is a flowchart of the operating process according to the first example of the present invention;

FIG. 8 is a block diagram of the configuration of the information processing device according to a second example of the present invention;

FIG. 9 is a flowchart of an operation of the acknowledgment reception unit shown in FIG. 8;

FIG. 10 is a block diagram of the configuration of the information processing device according to a third example of the present invention;

FIG. 11 is a flowchart of the operating process according to the third example of the present invention;

FIG. 12 is a flowchart of the operating process according to the third example of the present invention;

FIG. 13 is a flowchart of the operating process according to the third example of the present invention;

FIG. 14 is a flowchart of the operating process according to the third example of the present invention;

FIG. 15 shows an operation of re-transmitting a packet when a fault occurs according to the third example of the present invention;

FIG. 16 is a block diagram of the configuration of the information processing device according to a fourth example of the present invention;

FIG. 17 is a block diagram of the configuration of the information processing system using the information processing device shown in FIG. 16;

FIG. 18 is an explanatory view of the operation of the information processing system according to the fourth example of the present invention;

FIG. 19 is an explanatory view of the operation of the information processing system according to the fourth example of the present invention;

FIG. 20 is an explanatory view of the operation of the information processing system according to the fourth example of the present invention;

FIG. 21 is an explanatory view of the operation of the information processing system according to the fourth example of the present invention;

FIG. 22 is a flowchart of the operation of the information processing system according to the fourth example of the present invention;

FIG. 23 is a flowchart of the operation of the information processing system according to the fourth example of the present invention;

FIG. 24 is a block diagram of the configuration of the information processing device according to the fifth example of the present invention;

FIG. 25 is a block diagram of the configuration of the information processing system using the information processing device shown in FIG. 24;

FIG. 26 is an explanatory view of the operation of the information processing system according to the fifth example of the present invention;

FIG. 27 is an explanatory view of the operation of the information processing system according to the fifth example of the present invention;

FIG. 28 is an explanatory view of the operation of the information processing system according to the fifth example of the present invention;

FIG. 29 is an explanatory view of the operation of the information processing system according to the fifth example of the present invention;

FIG. 30 is an explanatory view of the operation of the information processing system according to the fifth example of the present invention;

FIG. 31 shows an example of a conventional redundant device; and

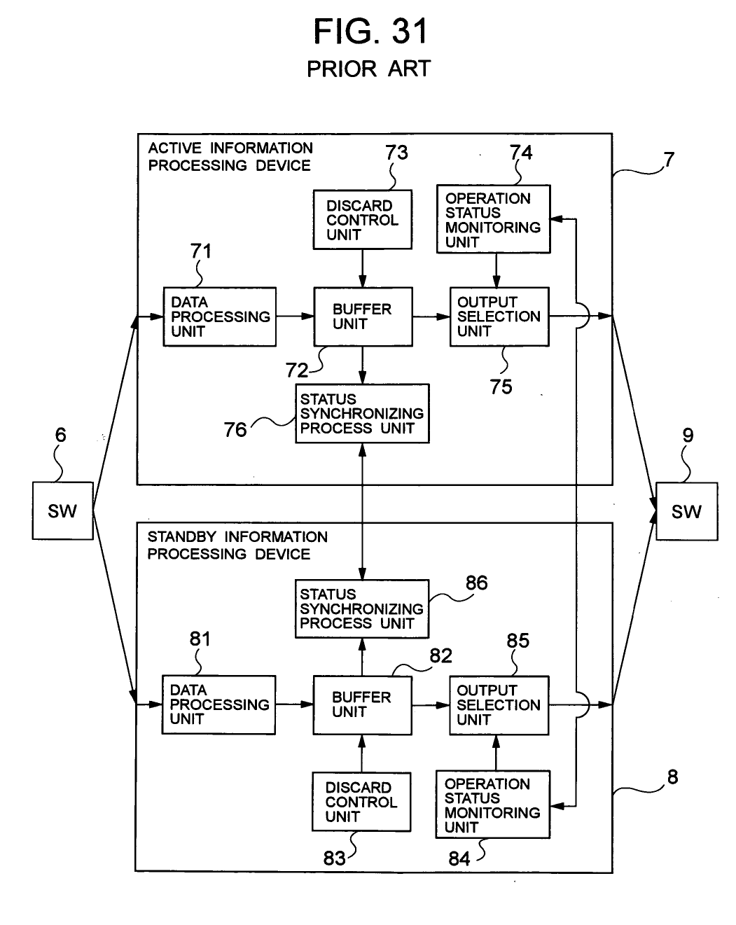

FIG. 32 shows a synchronizing process between the active information processing device and the standby information processing device in FIG. 31.

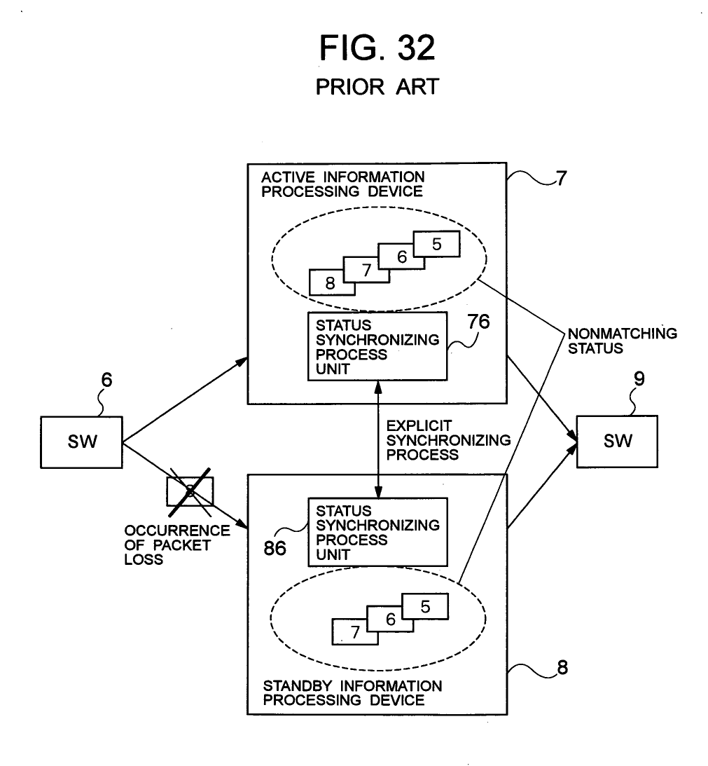

### DETAILED DESCRIPTION OF THE PREFERRED EMBODIMENTS

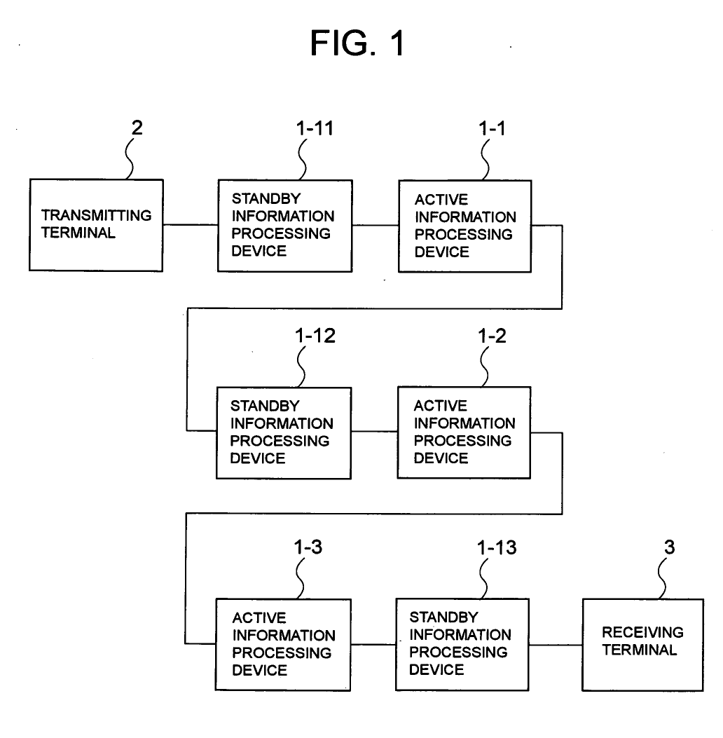

The embodiments of the present invention are explained below by referring to the attached drawings. FIG. 1 is a block diagram of the configuration of the information processing system according to an embodiment of the present invention. In FIG. 1, the information processing system according to an embodiment of the present invention comprises a transmitting terminal 2, a receiving terminal 3, active information processing devices 1-1 to 1-3, and standby information processing devices 1-11 to 1-13.

In the information processing system according to the embodiment of the present invention, a pair of the active information processing device 1-1 and the standby information processing device 1-11, a pair of the active information processing device 1-2 and the standby information processing device 1-12, and a pair of the active information processing device 1-3 and the standby information processing device 1-13 are operated.

During the normal operation in which no fault is detected, the standby information processing device 1-11 is arranged closest to the transmitting terminal 2 in a set of the information processing devices closest to the transmitting terminal 2, and the standby information processing device 1-13 is arranged closest to the receiving terminal 3 in a set of the information processing devices closest to the receiving terminal 3.

In the other sets, the standby information processing device 1-12 can be arranged closer to the transmitting terminal 2 or the receiving terminal 3 so that the both sides of each information processing device operated as an active system can be protected by an active or standby information processing device in the normal operation. The active information processing devices 1-1 to 1-3 and the standby information processing devices 1-11 to 1-13 are the information processing devices having the same configurations because a system is switched from an active system to a standby system when a fault occurs.

Thus, in the embodiment according to the present invention, an adjacent active or standby information processing device can re-transmit a discarded packet by performing an operation using a redundant configuration of the serially connected active information processing devices 1-1 to 1-3 and standby information processing devices 1-11 to 1-13 although the active information processing devices 1-1 to 1-3 become faulty and the packets accumulated in the information processing devices are discarded, thereby realizing a high-reliability information processing system.

In the embodiments of the present invention, by serially connecting the active information processing devices 1-1 to 1-3 and the standby information processing devices 1-11 to 1-13, and selecting outputting a packet accumulated in a buffer by the standby information processing devices 1-11 to 1-13, or outputting an input packet directly, the standby information processing device can hold the same status as the partner active information processing device. Therefore, when the active information processing device becomes faulty, the process can be continues with the standby information processing device taking over the status of the active information processing device.

Thus, according to the embodiment of the present invention, a standby system can be synchronous with an active system only by connecting the standby system in series to the active system at the stage before the active system, and holding input data in the standby system. Therefore, the load of the status synchronizing process can be reduced. Since the data input to the active system is constantly output by the standby system, an explicit status synchronizing process, that is, the process of confirming the matching status of the data accumulated in the buffer, copying the data when a nonmatching result is detected, or accumulating the data in the buffer, etc., is not required.

To acquire the above-mentioned effect in the serial arrangement between the active information processing devices 1-1 to 1-3 and the standby information processing devices 1-11 to 1-13, the standby information processing device 1-11 is arranged closer to the transmitting terminal 2 than the active information processing device 1-1 in the set closest to the transmitting terminal 2, the standby information processing device 1-13 is arranged closer to the receiving terminal 3 than the active information processing device 1-3 in the set closest to the receiving terminal 3, and they are connected in series. In the embodiment according to the present invention, three sets of the active information processing devices 1-1 to 1-3 and the standby information processing devices 1-11 to 1-13 are prepared, but the number of sets is not limited to three, that is, there can be two, four, or more sets.

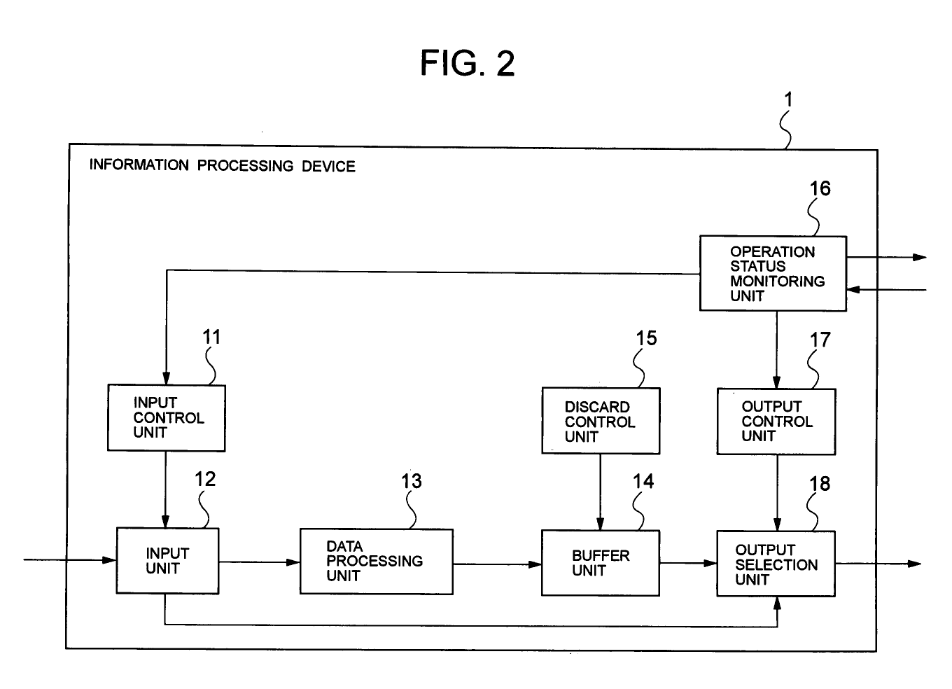

A first example of the present invention is explained below by referring to the attached drawings. FIG. 2 is a block diagram of the configuration of the information processing device according to the first example of the present invention. The information processing device 1 according to the first example of the present invention corresponds to the active information processing devices 1-1 to 1-3 and the standby information processing devices 1-11 to 1-13 in the information processing system according to the embodiment of the present invention shown in FIG. 1.

In FIG. 2, the information processing device 1 comprises an input control unit 11, an input unit 12, a data processing unit 13, a buffer unit 14, a discard control unit 15, an operation status monitoring unit 16, an output control unit 17, and an output selection unit 18. The operations of the input control unit 11, the data processing unit 13, the discard control unit 15, the operation status monitoring unit 16, and the output control unit 17 can be realized by the CPU (central processing unit) not shown in the attached drawings executing the program stored in the memory (recording medium) not shown in the attached drawings. The buffer unit 14 can be set as a storage medium in one memory unit (not shown in the attached drawings), and the memory can be used also as the memory storing the above-mentioned program.

The input control unit 11 controls the output of the data (packets) input to the input unit 12 depending on the operation status (active system or standby system). That is, when the device 1 is an active system, the input unit 12 outputs the input data only to the data processing unit 13 under the control of the input control unit 11. If the device 1 is a standby system, the input data is output to the data processing unit 13 under the control of the input control unit 11, and the input data is output directly to the output selection unit 18.

The data processing unit 13 performs a process on the data input from the input unit 12 for communications with another device, and outputs the processed data to the buffer unit 14. The buffer unit 14 temporarily stores the data from the data processing unit 13, discards the accumulated data under the control of the discard control unit 15, and outputs the accumulated data to the output selection unit 18. The discard control unit 15 controls the discard of the packets accumulated in the buffer unit 14.

The operation status monitoring unit 16 monitors the operation statuses of the device 1 and an adjacent information processing device (a partner to the device 1). The output control unit 17 controls the method for outputting data depending on the operation status of the device 1 monitored by the operation status monitoring unit 16. That is, when the device 1 is a standby system, the output control unit 17 allows the output selection unit 18 to select the data from the input unit 12, and output the data to the subsequent stage. In addition, when the device 1 is an active system, the output control unit 17 allows the output selection unit 18 to select the data from the buffer unit 14, and output the data to the subsequent stage. FIG. 2 only shows the configuration relating to the communications from left to right relating to the information processing device 1 shown in FIG. 2, and the configuration relating to the communication from right to left is omitted.

In the first example according to the present invention, the flow of data depends on whether the information processing device 1 is an active system or a standby system. The flow of the data is explained below about the case in which the information processing device 1 operates as an active system and the case in which it operates as a standby system. First, the flow of the data when the information processing device 1 operates as an active system is explained below.

When the information processing device 1 operates as an active system, a monitor result that the device 1 is an active system is input from the operation status monitoring unit 16 to the input control unit 11. Therefore, the data input to the input unit 12 is controlled to be input to the data processing unit 13. The input unit 12 outputs the input data to the data processing unit 13 under the control of the input control unit 11. The data processing unit 13 performs a necessary process on the data input from the input unit 12 (for example, a necessary process for the communication with the adjacent information processing device), and outputs the data to the buffer unit 14.

The buffer unit 14 temporarily stores the data processed by the data processing unit 13, and sequentially outputs the accumulated data to the output selection unit 18. Since the monitor result that the device 1 is an active system is input from the operation status monitoring unit 16, the output control unit 17 controls the output selection unit 18 to select and output the data from the buffer unit 14. The output selection unit 18 selects the data from the buffer unit 14 and outputs the data to the subsequent stage.

On the other hand, when the information processing device 1 operates as a standby system, the monitor result that the device 1 is a standby system is input from the operation status monitoring unit 16 to the input control unit 11. Therefore, the data input to the input unit 12 is controlled to be input to the data processing unit 13, and to be input directly to the output selection unit 18. The input unit 12 outputs the input data to the data processing unit 13, and outputs the input data to the output selection unit 18 under the control of the input control unit 11.

Since the monitor result that the device 1 is a standby system is input from the operation status monitoring unit 16, the output control unit 17 controls the output selection unit 18 to select and output the data from the input unit 12. The output selection unit 18 selects the data from the input unit 12 and outputs it to the subsequent stage. The discard control unit 15 monitors the accumulation status of the buffer unit 14, and appropriately discards the data of the buffer unit 14 such that the buffer unit 14 is not filled with the data to its capacity.

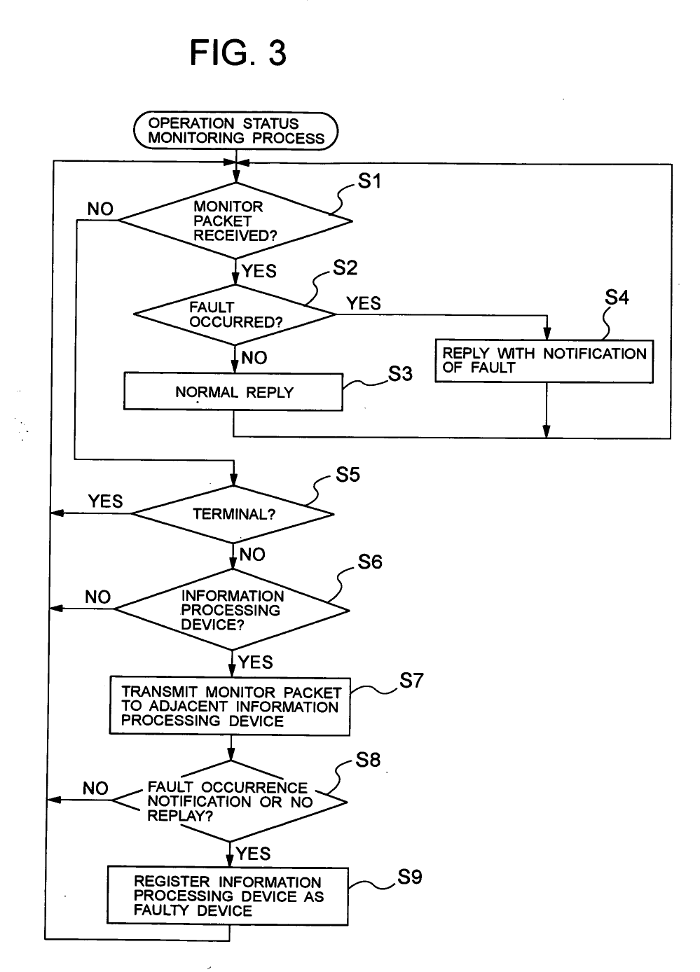

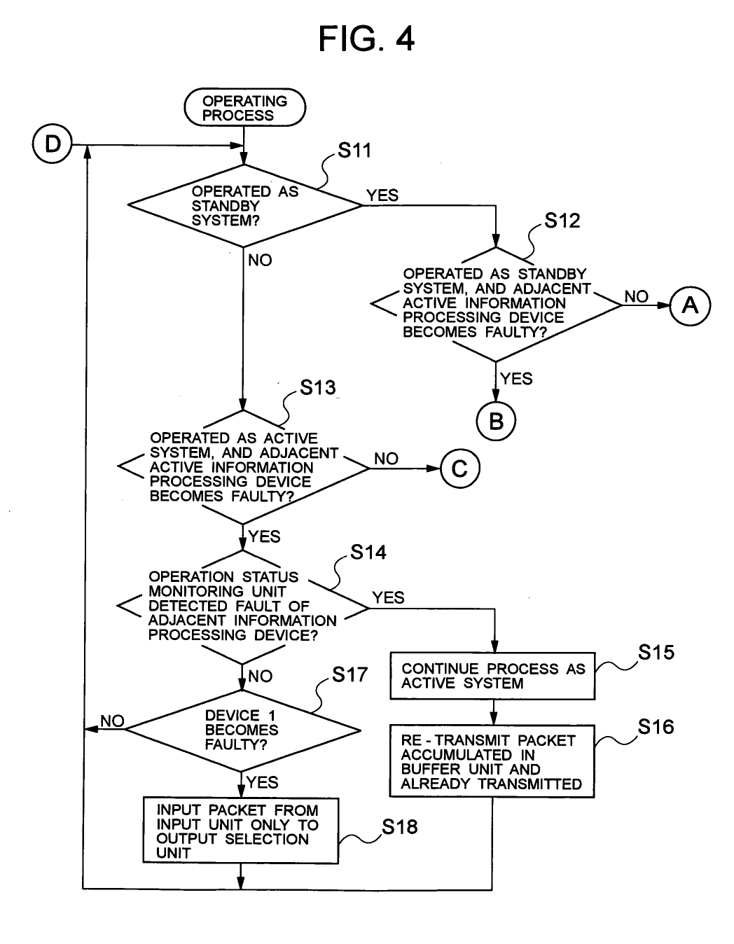

FIG. 3 is a flowchart of the operation status monitoring process according to the first example of the present invention. FIGS. 4 to 7 are flowcharts of the operating process according to the first example of the present invention. The operation of the information processing device 1 according to the first example of the present invention is explained by referring to FIGS. 1 to 7. The process shown in FIG. 3 and the processes shown in FIGS. 4 to 7 are realized by the CPU of the information processing device 1 executing the program stored in the memory (recording medium).

The operation status monitoring unit 16 of the information processing device 1 holds the identification information whether each of the two devices directly adjacent to the device 1 is a terminal, a partner information processing device or a non-partner information processing device. If the adjacent device is any information processing device (steps S5, S6 shown in FIG. 3), the operation status monitoring unit 16 monitors the operation status of the adjacent information processing device (steps S7 to S9 shown in FIG. 3).

That is, the operation status monitoring unit 16 transmits a monitor packet to the adjacent information processing device (step S7 shown in FIG. 3). If there is no reply to this, or a reply informing that a fault has occurred is received (step S8 shown in FIG. 3), the adjacent information processing device is registered as a device in a faulty state (step S9 shown in FIG. 3). The fault refers to the status other than a normal operation status of an information processing device such as a fault of an information processing device, the overload state of the CPU, the high use rate of the memory, the traffic rate exceeding a predetermined value, etc.

On the other hand, when the information processing device 1 receives a monitor packet from the adjacent information processing device (step S1 shown in FIG. 3), and when there is no fault in the device 1 (step S2 shown in FIG. 3), a normal reply is issued (step S3 shown in FIG. 3). If a fault has occurred in the device 1 (step S2 shown in FIG. 3), a reply informing that a fault has occurred is issued (step S4 shown in FIG. 3).

The operations performed when the information processing device 1 is operated as a standby system, when it is operated as an active system, when a fault occurs in an adjacent active information processing system when the information processing device 1 is operated as a standby system, and when a fault occurs in an adjacent standby information processing system when the information processing device 1 is operated as an active system are explained below.

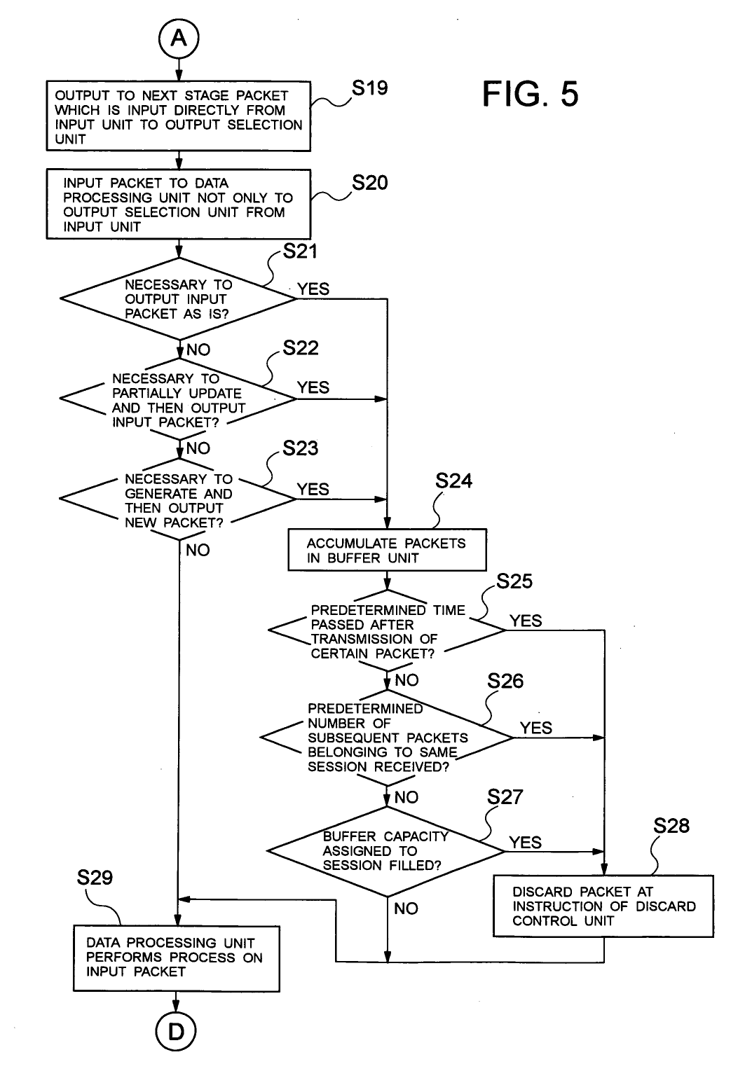

When the information processing device 1 is operated as a standby system (step S11 shown in FIG. 4), and when there is no fault occurring in the adjacent active information processing device (step S12 shown in FIG. 4), it is necessary to output an input packet which is input directly from the input unit 12 to the output selection unit 18, and the input unit 12 and the output selection unit 18 performs the process (step S19 shown in FIG. 5). However, it is necessary to store the output packet in the buffer unit 14 in the information processing device 1 for preparation of a fault of the adjacent information processing device.

Therefore, the input unit 12 not only inputs a packet to the output selection unit 18, but also inputs the packet to the data processing unit 13 (step S20 shown in FIG. 5). The data processing unit 13 performs the above-mentioned process on the input packet (step S29 shown in FIG. 5).

When it is necessary to output an input packet as is (step S21 shown in FIG. 5), when it is necessary to partially update and output an input packet (step S22 shown in FIG. 5), and when it is necessary to generate and output a new packet (step 23 shown in FIG. 5), the data processing unit 13 stores the packets in the buffer unit 14 (step S24 shown in FIG. 5).

Since the information processing device 1 operates as a standby system, the buffer unit 14 does not output a packet. However, since the capacity of the buffer unit 14 is finite, the buffer unit 14 discards a corresponding packet (step S28 shown in FIG. 5) at an instruction of the discard control unit 15 when a predetermined time passes after a packet is transmitted (step S25 shown in FIG. 5), when a predetermined number of subsequent packets belonging to the same session are received (step S26 shown in FIG. 5), when the capacity of the buffer assigned to the session becomes full (step S27 shown in FIG. 5), etc.

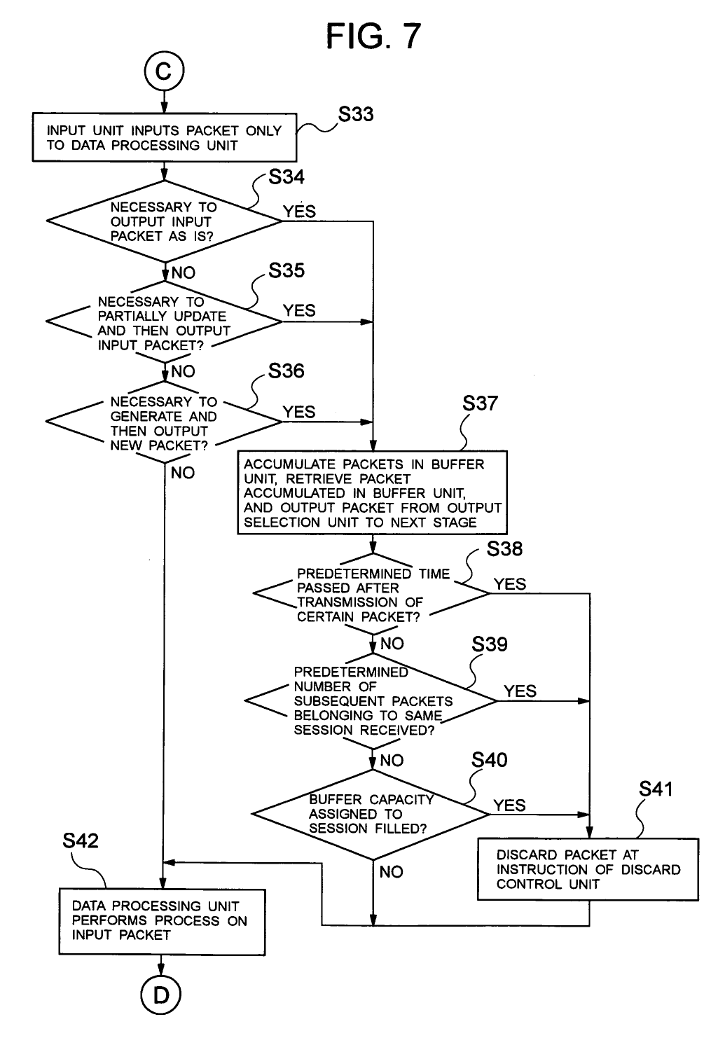

When the information processing device 1 is operated as an active system (step S11 shown in FIG. 4), and when there is no fault occurring in the adjacent active information processing device (step S13 shown in FIG. 4), the input control unit 11 inputs a packet from the input unit 12 to the data processing unit 13 only (step S33 shown in FIG. 7). The data processing unit 13 performs the above-mentioned process on the input packet (step S42 shown in FIG. 7).

That is, when it is necessary to output an input packet as is (step S34 shown in FIG. 7), when it is necessary to partially update and output an input packet (step S35 shown in FIG. 7), and when it is necessary to generate and output a new packet (step 36 shown in FIG. 7), the data processing unit 13 stores the packets in the buffer unit 14. The output control unit 17 retrieves packets stored in the buffer unit 14, and outputs them from the output selection unit 18 to the next stage (step 37 shown in FIG. 7).

However, when the packets are retrieved and output from the buffer unit 14, the packets are not deleted from the buffer unit 14, but are accumulated for a fault of an adjacent information processing device. Only in the above-mentioned cases, the packets are discarded at an instruction of the discard control unit 15. That is, the buffer unit 14 discards a corresponding packet (step S41 shown in FIG. 7) at an instruction of the discard control unit 15 when a predetermined time passes after a packet is transmitted (step S38 shown in FIG. 7), when a predetermined number of subsequent packets belonging to the same session are received (step S39 shown in FIG. 7), when the capacity of the buffer assigned to the session becomes full (step S40 shown in FIG. 7), etc.

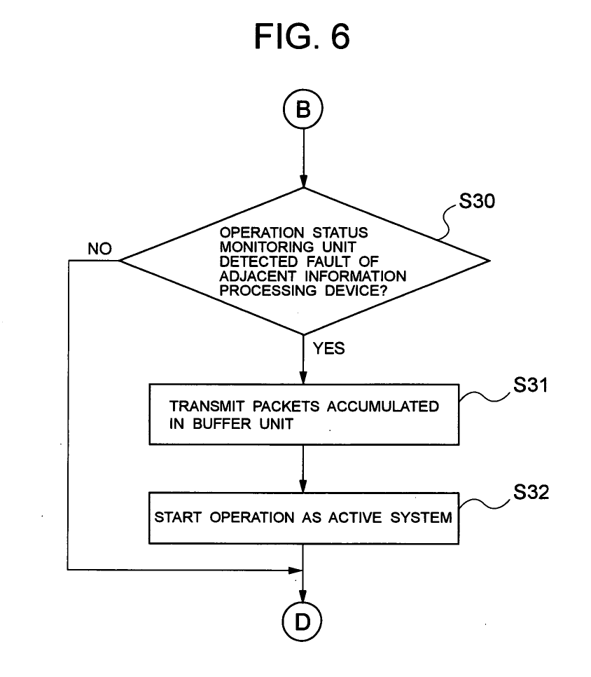

Then, the operation performed when there is a fault occurring in the adjacent active information processing device (step S12 shown in FIG. 4) during the operation of the information processing device 1 as a standby system is explained below. When the operation status monitoring unit 16 detects a fault in the adjacent information processing device (step S30 shown in FIG. 6), the information processing device 1 starts the operation as an active system instead of the faulty information processing device, and performs the above-mentioned operations as an active system (step S32 shown in FIG. 6).

At this time, the information processing device 1 transmits packets accumulated in the buffer unit 14 (step S31 shown in FIG. 6), and starts the process as an active system. Therefore, the packets lost by the faulty information processing device can be re-transmitted.

Furthermore, the operation performed when there is a fault occurring in the adjacent active information processing device (step S13 shown in FIG. 4) during the operation of the information processing device 1 as an active system is explained below. When the operation status monitoring unit 16 detects a fault in the adjacent information processing device (step S14 shown in FIG. 4), the information processing device 1 continues the process as an active system (FIG. S15 shown in FIG. 4).

At this time, the buffer unit 14 does not output a packet not transmitted yet to the adjacent information processing device, but the packet accumulated in the buffer unit 14 and already transmitted is re-transmitted to the adjacent information processing device (step S16 shown in FIG. 4), thereby successfully re-transmitting the packet lost by the faulty device.

When the information processing device 1 becomes faulty (step S17 shown in FIG. 4), the input control unit 11 controls the input unit 12 to input a packet only to the output selection unit 18 (step S18 shown in FIG. 4). Thus, the information processing device 1 enters a state in which a portion for receiving a packet is directly connected to a portion for transmitting a packet, which is equivalent to the state in which the faulty device 1 is bypassed.

Thus, according to the first example, by performing an operation with a redundant configuration using the serially connected active information processing devices 1-1 to 1-3 and standby information processing devices 1-11 to 1-13, packets can be re-transmitted by an adjacent active or standby information processing device although any of the active information processing devices 1-1 to 1-3 becomes faulty and the packets accumulated in the faulty device have been discarded, thereby realizing a high-reliability information processing system.

In the first example, a standby information processing device can be in the same state as a partner active information processing device by the mechanism of the input unit 12 and the output selection unit 18. Therefore, when the active information processing device becomes faulty, the standby information processing device can continue the process with the status of the active system taken over by the standby information processing device.

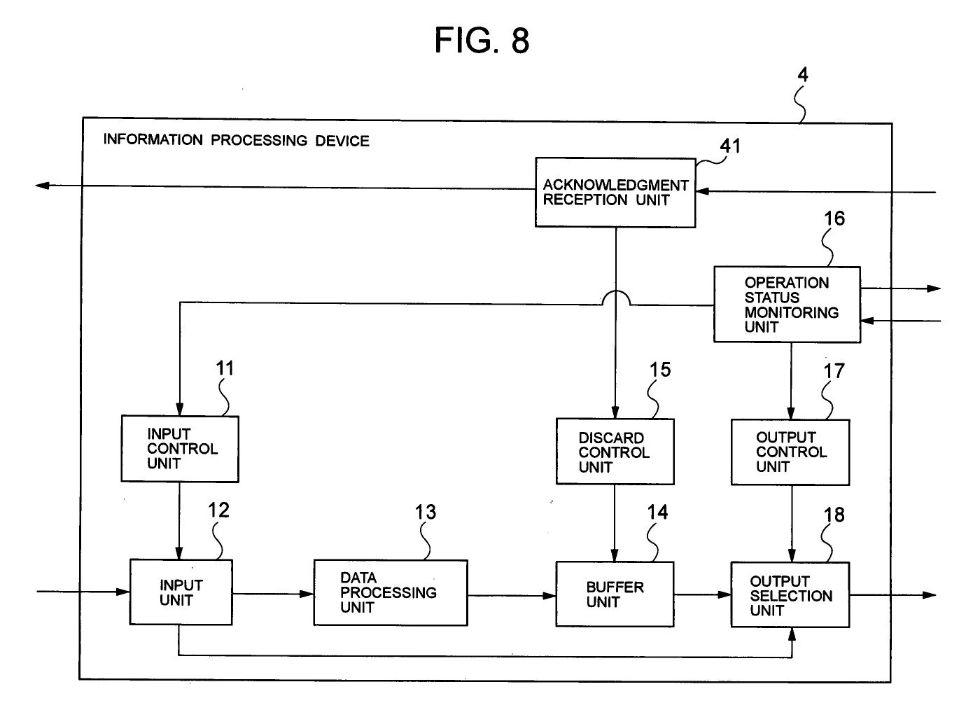

FIG. 8 is a block diagram of the configuration of the information processing device according to a second example of the present invention. An information processing device 4 according to the second example of the present invention corresponds to the active information processing devices 1-1 to 1-3 and the standby information processing devices 1-11 to 1-13 in the information processing system according to the embodiment of the present invention shown in FIG. 1.

In FIG. 8, the information processing device 4 according to the second example of the present invention has the same configuration as the information processing device 1 according to the first example of the present invention shown in FIG. 2 except that an acknowledgment reception unit 41 for monitoring an acknowledgment to the data output from the device 4 is provided. The same components are assigned the same reference numerals. The operations of the same components are the same as in the first example of the present invention described above.

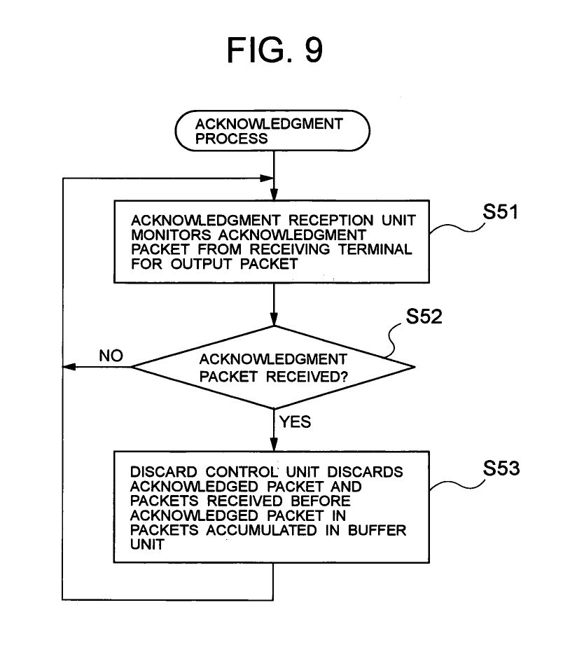

FIG. 9 is a flowchart of the operation of the acknowledgment reception unit 41 shown in FIG. 8. The operations of the acknowledgment reception unit 41 are explained below by referring to FIGS. 8 and 9. The operations of the acknowledgment reception unit 41, that is, the processes shown in FIG. 9, are realized by the CPU executing the program stored in the memory (recording medium) as in the case of the information processing device 1 according to the first example of the present invention.

The acknowledgment reception unit 41 of the information processing device 4 monitors an acknowledgment packet from the receiving terminal 3 to the packet output from the device 4 when the device 4 is operated as an active or standby system (step S51 shown in FIG. 9). For example, when an output packet is a packet in the TCP (transmission control protocol) session, the acknowledgment packet is an ACK (acknowledgment) packet of the TCP for the output packet. The acknowledgment reception unit 41 monitors an acknowledgment packet for each session to which data belongs, monitors an acknowledgment packet for each session to which data belongs at predetermined time intervals, or monitors an acknowledgment packet for each session to which data belongs at a predetermined rate.

When the acknowledgment reception unit 41 confirms the reception of an acknowledgment packet (step S52 shown in FIG. 9), the discard control unit 15 discards an acknowledged packet and packets received before the acknowledged packet in the packets accumulated on the buffer unit 14 (step S53 shown in FIG. 9). The discard control unit 15 may discard packets accumulated in the buffer unit 14 a predetermined time before an acknowledged packet in the session to which the acknowledged data belongs, and discard packets a predetermined amount older than the acknowledged packet in the session to which the acknowledged data belongs.

Thus, in the second example, as in the first example of the present invention, a high-reliability information processing system can be realized. Furthermore, according to the second example, the packets accumulated in the buffer unit 14 are appropriately discarded by monitoring the acknowledgment packet from the receiving terminal 3. Therefore, a necessary capacity for the buffer unit 14 can be reduced, thereby decreasing the number of packets to be re-transmitted when a fault occurs.

In the second example, the packet and the corresponding acknowledgment are explained for example, but instead the data in the application layer and the corresponding acknowledgment, and the request in the application layer and the corresponding response can also be used.

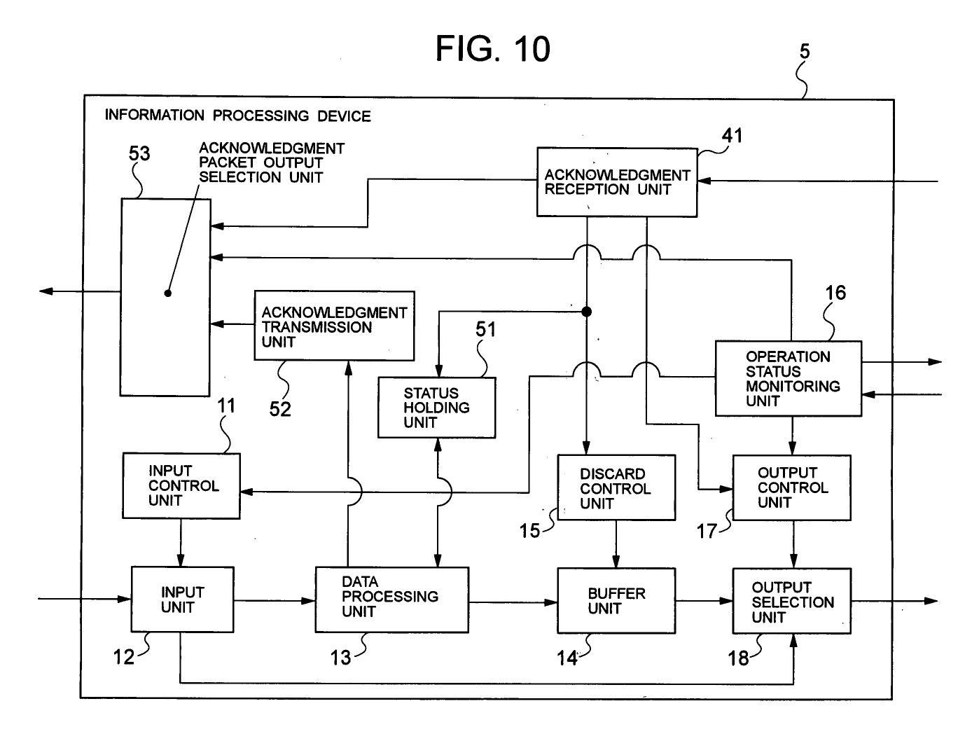

FIG. 10 is a block diagram of the configuration of the information processing device according to a third example of the present invention. An information processing device 5 according to the third example of the present invention corresponds to the active information processing devices 1-1 to 1-3 and the standby information processing devices 1-11 to 1-13 in the information processing system according to the embodiment of the present invention shown in FIG. 1.

In FIG. 10, the information processing device 5 according to the third example of the present invention comprises a status holding unit 51, an acknowledgment transmission unit 52, and an acknowledgment packet output selection unit 53, and the output of the acknowledgment reception unit 41 is input to the discard control unit 15, the output control unit 17, the status holding unit 51, and the acknowledgment packet output selection unit 53. Otherwise, the same configuration as the information processing device 4 according to the second example of the present invention shown in FIG. 8 is used, and the same components are assigned the same reference numerals. The operations of the same components are the same as in the second example of the present invention, but the acknowledgment received by the acknowledgment reception unit 41 is input to the acknowledgment packet output selection unit 53.

The status holding unit 51 holds the process status (for example, the status of how many input packets have been input, and to what extent the process has been performed, etc.) of the data processing unit 13. The acknowledgment transmission unit 52 generates an acknowledgment packet depending on the process result of the data processing unit 13. In this case, before the data processing unit 13 processes the input data from the input unit 12, it compares the input data with the process status of the status holding unit 51, passes the process status of the status holding unit 51 to the acknowledgment transmission unit 52 if the process of the input data is completed, and allows the acknowledgment transmission unit 52 to generate an acknowledgment packet indicating to what extent data has been processed (an acknowledgment packet indicating data received and processed by the data processing unit 13).

The acknowledgment packet output selection unit 53 selects outputting an acknowledgment packet received from the acknowledgment reception unit 41, or outputting an acknowledgment packet generated by the acknowledgment transmission unit 52, and outputs the selected acknowledgment packet to the device at the preceding stage. That is, when a monitor result that the device 5 is a standby system is input from the operation status monitoring unit 16, the acknowledgment packet output selection unit 53 outputs the acknowledgment packet received by the acknowledgment reception unit 41 to the device at the preceding stage, and suppresses the output to the device at the preceding stage of the acknowledgment packet generated by the acknowledgment transmission unit 52. When the monitor result that the device 5 is an active system is input from the operation status monitoring unit 16, the acknowledgment packet output selection unit 53 outputs the acknowledgment packet generated by the acknowledgment transmission unit 52 to the device at the preceding stage.

When the monitor result that the device 5 is changed from the standby system to the active system is input from the operation status monitoring unit 16 to the output control unit 17, the output control unit 17 suppresses the output of the packets before the packet specified by the acknowledgment packet received by the acknowledgment reception unit 41. For example, when the acknowledgment packet indicating to what extent data has been processed reaches the acknowledgment reception unit 41, the output control unit 17 suppresses the output of packets before the packet specified by the acknowledgment packet. In this case, the status held by the status holding unit 51 is changed according to the information specified by the acknowledgment packet. The status holding unit 51 and the buffer unit 14 can be set as a storage area in one memory unit (not shown in the attached drawings), and the memory can be also used to store the above-mentioned program.

In the third example of the present invention, the flow of data depends on whether the information processing device 5 operates as an active system or a standby system. The flow of the data is explained below about the case in which the information processing device 5 operates as an active system and the case in which it operates as a standby system. However, when the information processing device 5 operates as a standby system, it is similar to that in the second example according to the present invention except that the acknowledgment packet output selection unit 53 selects and outputs the acknowledgment packet received by the acknowledgment reception unit 41 to the device at the preceding stage. Therefore, the explanation of the operation is omitted here, and the flow of the data when the information processing device 5 operates as an active system is explained below.

When the information processing device 5 is operated as an active system, the operation status monitoring unit 16 inputs to the input control unit 11 the monitor result that the device 5 is an active system. Therefore, the data input to the input unit 12 is controlled to be input to the data processing unit 13. The input unit 12 outputs the input data to the data processing unit 13 under the control of the input control unit 11.

Before the data processing unit 13 processes the input data from the input unit 12, it compares the input data with the process status of the status holding unit 51. If the process of the input data has not been completed, the data processing unit 13 performs a necessary process (for example, a process required for the communication with the adjacent information processing device) on the input data, outputs the processed data to the buffer unit 14, and holds the process status in the status holding unit 51. Simultaneously, the data processing unit 13 passes the process result to the acknowledgment transmission unit 52. Therefore, the acknowledgment transmission unit 52 generates an acknowledgment packet based on the process result of the data processing unit 13. The acknowledgment packet generated by the acknowledgment transmission unit 52 is output from the acknowledgment packet output selection unit 53 to the device at the preceding stage.

If the process on the input data has been completed, the data processing unit 13 passes the process status of the status holding unit 51 to the acknowledgment transmission unit 52, and allows the acknowledgment transmission unit 52 to generate an acknowledgment packet indicating to what extent data has been processed. The acknowledgment transmission unit 52 generates the acknowledgment packet at an instruction of the data processing unit 13, and the generated acknowledgment packet is output from the acknowledgment packet output selection unit 53 to the device at the preceding stage. Thus, when a fault occurs in an active device at the stage before the information processing device 5 and the data in the buffer of a device changed from a standby system to an active system is transmitted, the extent of the process of the data, that is, which portion of the data is required can be announced.

The buffer unit 14 temporarily accumulates the data processed by the data processing unit 13, and sequentially outputs the accumulated data to the output selection unit 18. Since the monitor result that the device 5 is an active system is input from the operation status monitoring unit 16 to the output control unit 17, the output control unit 17 controls the output selection unit 18 to select and output the data from the buffer unit 14. The output selection unit 18 selects the data from the buffer unit 14 and outputs it to the next stage.

However, when the monitor result that the device 5 has been changed from a standby system to an active system is input from the operation status monitoring unit 16 to the output control unit 17, the output control unit 17 suppresses the output of packets before the packet specified by the acknowledgment packet received by the acknowledgment reception unit 41. For example, when the acknowledgment packet indicating the extent to which the process has been performed is received by the acknowledgment reception unit 41, the output control unit 17 suppresses the output of packets before the packet specified by the acknowledgment packet. In this case, the status held in the status holding unit 51 is also changed according to the information specified by the acknowledgment packet.

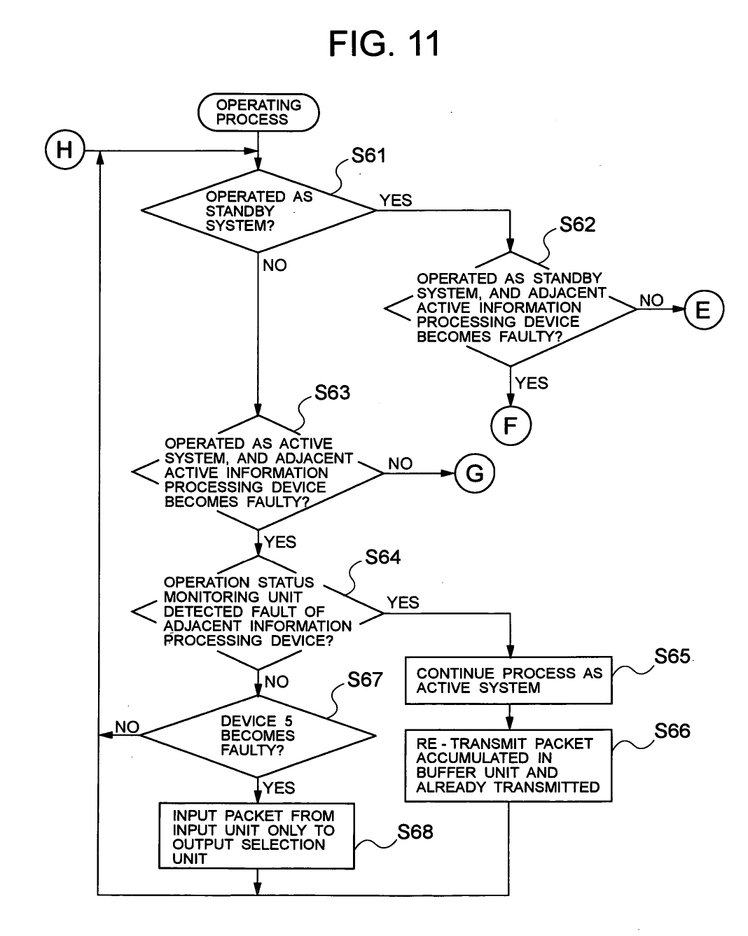

FIGS. 11 to 14 are flowcharts of the operating process according to the third example of the present invention. The operation of the information processing device 5 according to the third example of the present invention is explained below by referring to FIGS. 10 to 14. The processes shown in FIGS. 11 to 14 are realized by the CPU of the information processing device 5 executing the program stored in the memory (recording medium). The operation of the operation status monitoring unit 16 is similar to the operation according to the first example of the present invention. Therefore, the explanation of the operation is omitted here.

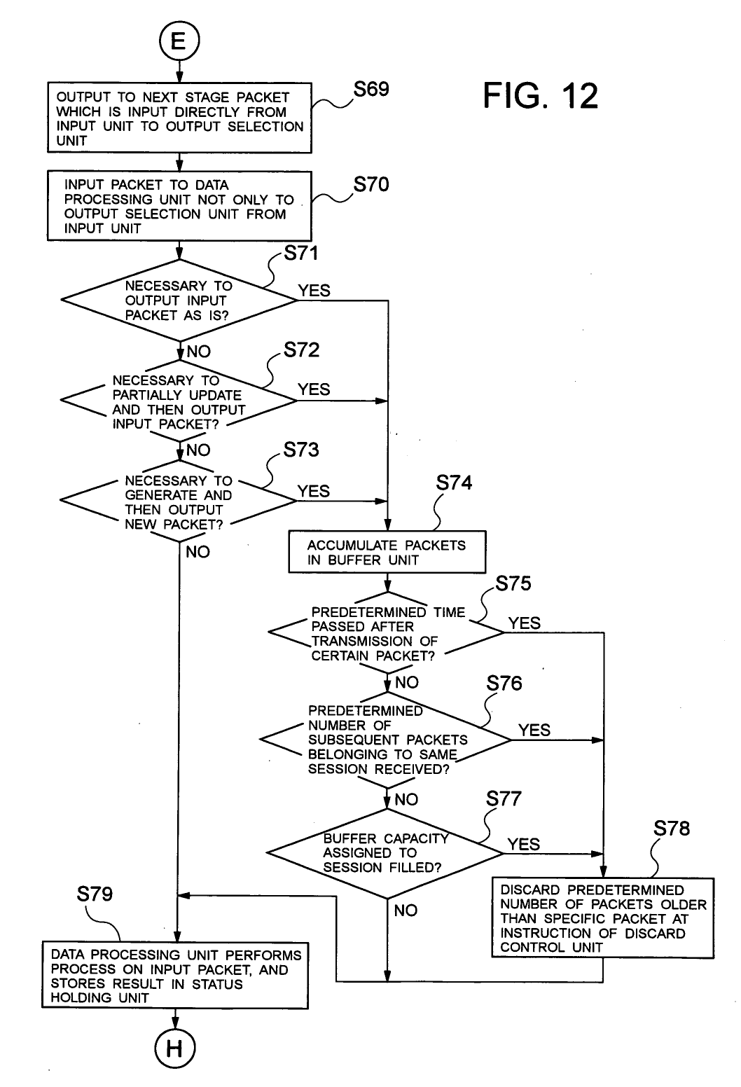

The information processing device 5 is operated as a standby system (step S61 shown in FIG. 11). When the adjacent active information processing device is not faulty (step S62 shown in FIG. 11), it is necessary to output an input packet which is input directly from the input unit 12 to the output selection unit 18, and the output selection unit 18 outputs to the next stage the input packet which is input directly from the input unit 12 (step S69 shown in FIG. 12). However, it is also necessary that the information processing device 5 stores the output packet in the buffer unit 14 for a fault of the adjacent information processing device.

Therefore, the input unit 12 not only inputs a packet to the output selection unit 18, but also inputs the packet to the data processing unit 13 (step S70 shown in FIG. 12). The data processing unit 13 performs a process for the input packet (for example, the process required in communication such as the reassignment of header information of a packet, etc.), and stores the result in the status holding unit 51 (step S79 shown in FIG. 12).

When it is necessary to output an input packet as is (step S71 shown in FIG. 12), when it is necessary to partially update and output an input packet (step S72 shown in FIG. 12), and when it is necessary to generate and output a new packet (step S73 shown in FIG. 12), the data processing unit 13 stores the packets in the buffer unit 14 (step S74 shown in FIG. 12).

As described above, since the information processing device 5 is operated as a standby system, the buffer unit 14 does not output a packet. However, since the capacity of the buffer unit 14 is finite, the buffer unit 14 discards a predetermined number of packets older than a corresponding packet (step S78 shown in FIG. 7) at an instruction of the discard control unit 15 when a predetermined time passes after a packet is transmitted (step S75 shown in FIG. 12), when a predetermined number of subsequent packets belonging to the same session are received (step S76 shown in FIG. 12), when the capacity of the buffer assigned to the session becomes full (step S77 shown in FIG. 12), etc.

For example, although the information processing device adjacent to the information processing device 5 issues acknowledgment for the hundredth packet, there is the possibility that a node becomes faulty the next moment, and before the hundredth packet is transmitted to the faulty node, the hundredth packet is discarded. Therefore, the information processing device 5 does not discard the hundredth packet after the acknowledgment is issued for the hundredth packet, but discards the packets older than the hundredth packet such as the fiftieth packet, thus holding the fifty-first packet to the hundredth packet. At this time, the packets to be discarded can be determined by referring to the buffer capacity of each information processing device and the value of the band delay product of a network.

In the third example, when the monitor result that the device 5 is a standby system is input from the operation status monitoring unit 16 to the acknowledgment packet output selection unit 53, the acknowledgment packet output selection unit 53 does not output the acknowledgment packet generated by the acknowledgment transmission unit 52, but outputs the acknowledgment packet received by the acknowledgment reception unit 41.

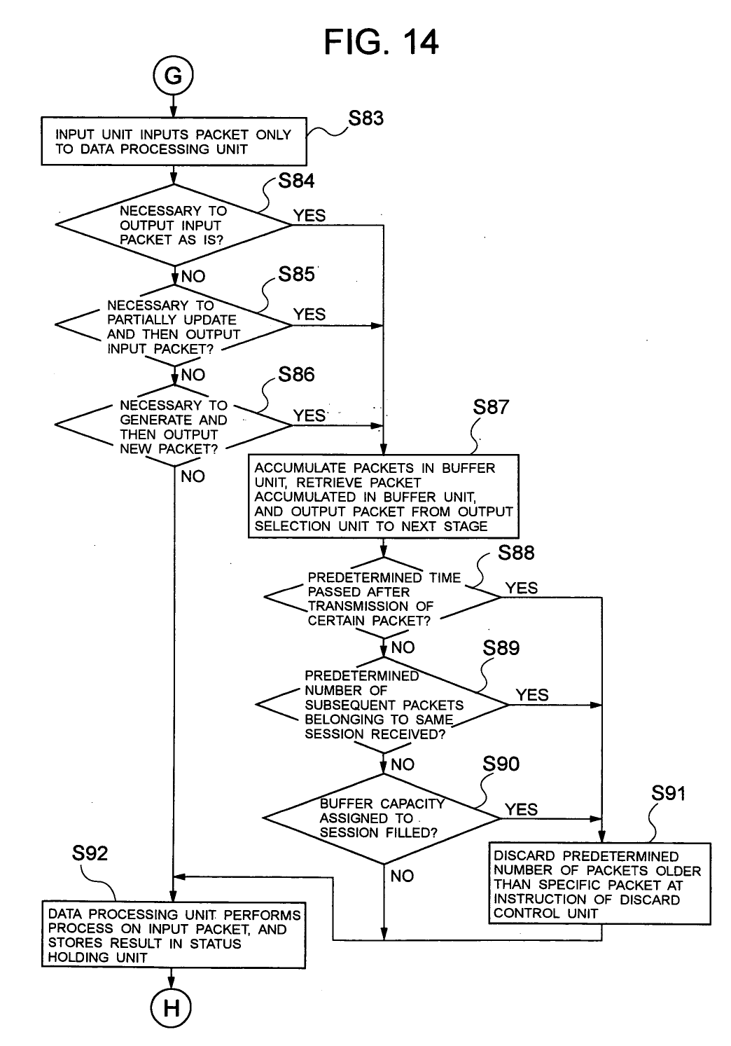

Then, when the information processing device 5 is operated as an active system (step S61 shown in FIG. 11) and the adjacent active information processing device is not faulty (step S63 shown in FIG. 11), the input unit 12 inputs a packet only to the data processing unit 13 (step S83 shown in FIG. 14). The data processing unit 13 performs a process on the input packet, and the process result is stored in the status holding unit 51 (step S92 shown in FIG. 14). The acknowledgment transmission unit 52 generates an acknowledgment packet for the input packet, and outputs the packet through the acknowledgment packet output selection unit 53.

When it is necessary to output an input packet as is (step S84 shown in FIG. 14), when it is necessary to partially update and output an input packet (step S85 shown in FIG. 14), and when it is necessary to generate and output a new packet (step 86 shown in FIG. 14), the data processing unit 13 stores the packets in the buffer unit 14. The output control unit 17 retrieves packets stored in the buffer unit 14, and outputs them from the output selection unit 18 to the next stage (step S87 shown in FIG. 14).

However, when a packet is retrieved and output from the buffer unit 14, the packet is not deleted from the buffer unit 14, but accumulated for a fault of the adjacent information processing device, and discarded at an instruction of the discard control unit 15 only in the following cases. That is, the buffer unit 14 discards a predetermined number of packets older than a corresponding packet (step S91 shown in FIG. 14) at an instruction of the discard control unit 15 when a predetermined time passes after a packet is transmitted (step S88 shown in FIG. 14), when a predetermined number of subsequent packets belonging to the same session are received (step S89 shown in FIG. 14), when the capacity of the buffer assigned to the session becomes full (step S90 shown in FIG. 14), etc.

When the acknowledgment packet for an output packet reaches the acknowledgment reception unit 41, the discard control unit 15 and the output control unit 17 perform a necessary process on the acknowledgment packet. That is, the discard control unit 15 performs an operation such as discarding packets accumulated in the buffer unit 14 before the packet specified by the acknowledgment packet received by the acknowledgment reception unit 41. Furthermore, the output control unit 17 suppresses the output of the packets before the packet specified by the acknowledgment packet received by the acknowledgment reception unit 41. For example, when the acknowledgment packet indicating to what extent data has been processed is received by the acknowledgment reception unit 41, the output control unit 17 suppresses the output of the packets before the packet specified by the acknowledgment packet. In this case, the status held by the status holding unit 51 is also changed according to the information specified by the acknowledgment packet.

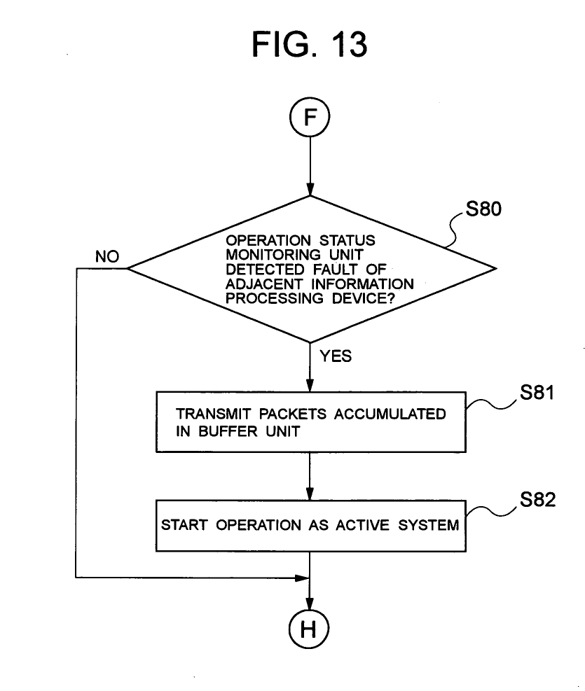

Next, the operation to be performed when the information processing device 5 is operated as a standby system, and when the adjacent active information processing device becomes faulty (step S62 shown in FIG. 11) is explained below. When the operation status monitoring unit 16 detects a fault of the adjacent information processing device (step S80 shown in FIG. 13), the information processing device 5 starts its operation as an active system for the information processing device in which a fault has been detected, and performs the above-mentioned operation as the active system (step S82 shown in FIG. 13).

At this time, the information processing device 5 first transmits packets accumulated in the buffer unit 14 (step S81 shown in FIG. 13), and then starts its process as an active system. Therefore, the device 5 can re-transmit packets lost in the information processing device in which a fault has been detected.

The operation performed when a fault occurs in the adjacent active information processing device while the information processing device 5 is operated as an active system is similar to the operation performed when a fault occurs in the adjacent active information processing device while the information processing device 1 according to the first example of the present invention is operated as an active system, the explanation of the operation is omitted here.

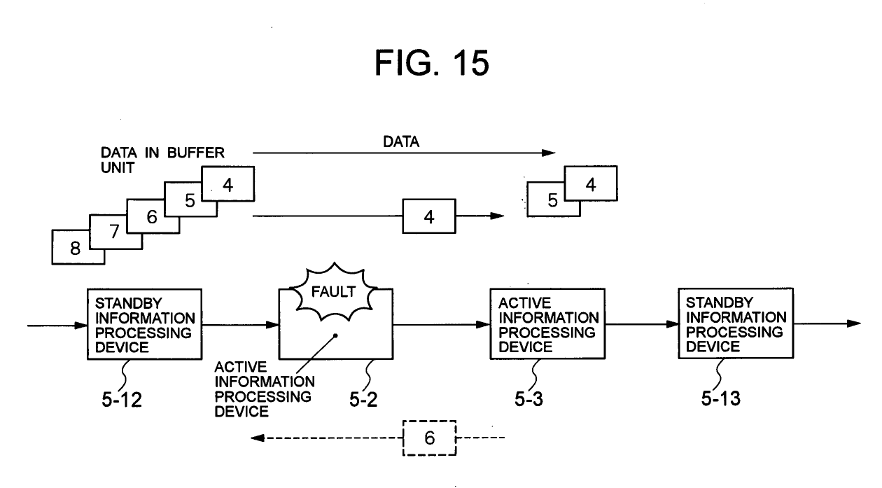

FIG. 15 shows the operation of re-transmitting a packet when a fault occurs according to the third example of the present invention. The operation of re-transmitting a packet when a fault occurs according to the third example of the present invention is explained below. FIG. 15 shows the operation performed when the information processing device 5 shown in FIG. 10 is used in the serial arrangement of the standby information processing device 1-12→the active information processing device 1-2→the active information processing device 1-3→the standby information processing device 1-13 (see FIG. 1).

When an active information processing device 5-2 becomes faulty and a standby information processing device 5-12 is switched to an active system, the standby information processing device 5-12 sequentially re-transmits to an active information processing device 5-3 the transmitted packets (packets transmitted before the fault has occurred in the active information processing device 5-2) “4”, “5”, “6”, “7” and “8” accumulated in the buffer unit 14.

At this time, if the packets “4” and “5” have been accumulated in the buffer unit 14 of the active information processing device 5-3, the active information processing device 5-3 acknowledges the reception of the packets “4” and “5”, and transmits to the standby information processing device 5-12 an acknowledgment packet to transmit packets starting from the packet “6” or to notify that the packets up to the packet “5” have been received.

Thus, the standby information processing device 5-12 sequentially transmits the packets “6”, “7”, and “8” of the packets “4”, “5”, “6”, “7”, and “8” accumulated in the buffer unit 14 to the active information processing device 5-3. Therefore, in the third example, although the active information processing device 5-2 becomes faulty and the packets accumulated in the active information processing device 5-2 have been discarded as described above, the standby information processing device 5-12 can re-transmit the packets discarded in the active information processing device 5-2, thereby realizing a high-reliability information processing system.

Thus, according to the third example, as in the first example of the present invention, a high-reliability information processing system can be realized. In addition, the third example can be applied to a device such as a TCP session repeater, a Web proxy, etc. for issuing acknowledgment for received data by, unlike a device such as a router for outputting received data as is, an information processing device, not the receiving terminal 3.

As described above, in the first to third examples of the present invention, by serially connecting a standby system arranged at the stage before an active system, the standby system can be synchronous with the active system only by holding the data input to the standby system, thereby reducing the load of the status synchronizing process. Since the data input to the active system is constantly output by the standby system, the explicit status synchronizing process, that is, the process of confirming the matching statuses of the data accumulated in the buffer, copying the data when the nonmatching statuses are detected, or accumulating the data in the buffer, etc., is not required.

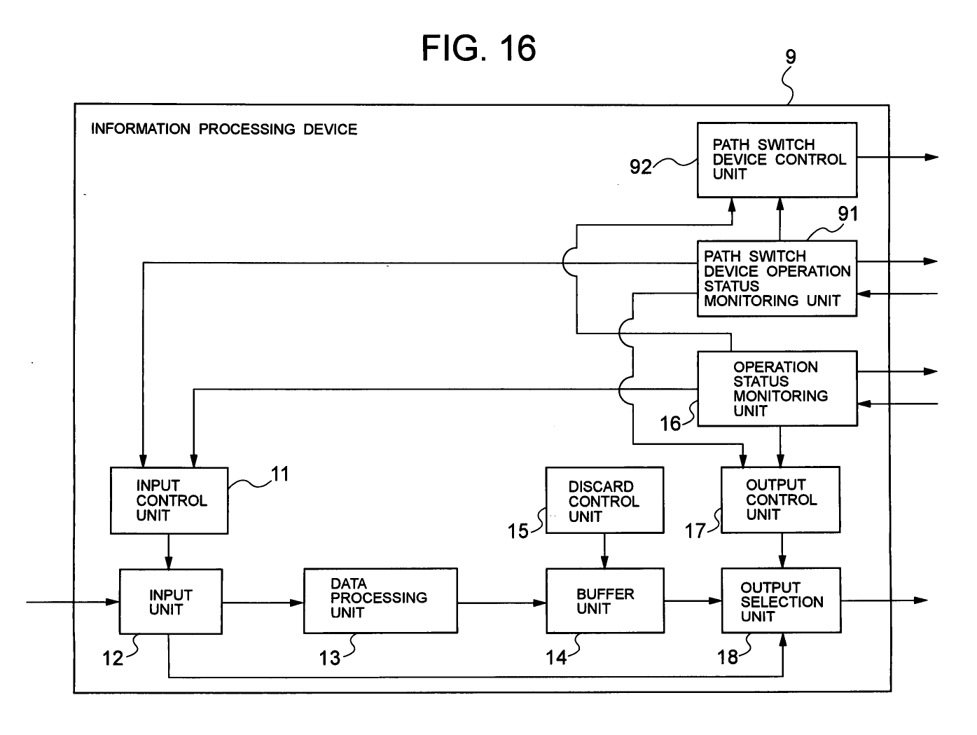

FIG. 16 is a block diagram showing the configuration of the information processing device according to a fourth example of the present invention. An information processing device 9 according to the fourth example of the present invention has the same configuration as the information processing device 1 according to the first example of the present invention shown in FIG. 1 except a path switch device operation status monitoring unit 91 and a path switch device control unit 92 newly added for the present example, and the same components are assigned the same reference numerals. The operations of the same components are similar to that according to the first example of the present invention. The path switch device operation status monitoring unit 91 monitors the operation status of a path switch device (not shown), and the path switch device control unit 92 controls the path of the path switch device.

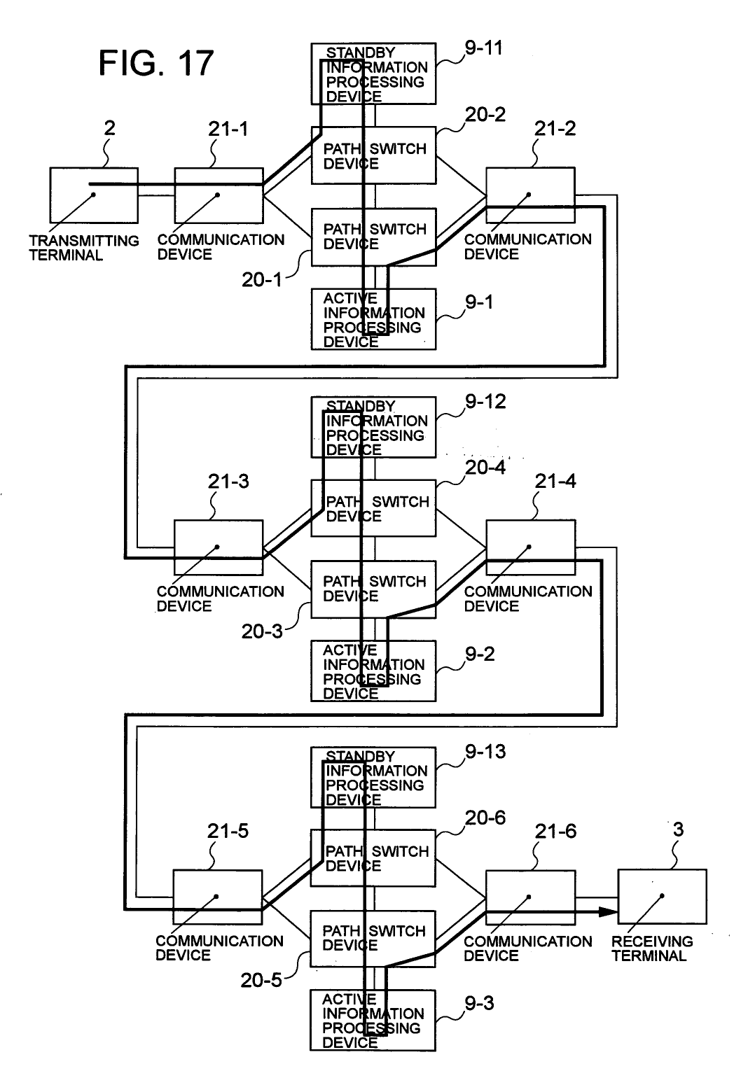

FIG. 17 is a block diagram of the configuration of the information processing system using the information processing device 9 shown in FIG. 16. In FIG. 17, the information processing system according to the fourth example of the present invention comprises the transmitting terminal 2, the receiving terminal 3, active information processing devices 9-1 to 9-3, standby information processing devices 9-11 to 9-13, first path switch devices 20-1, 20-3 and 20-5, second path switch devices 20-2, 20-4 and 20-6, first communication devices 21-1, 21-3 and 21-5 and second communication devices 21-2, 21-4 and 21-6. The active information processing devices 9-1 to 9-3 and the standby information processing devices 9-11 to 9-13 have the same configuration as the information processing device 9 shown in FIG. 16.

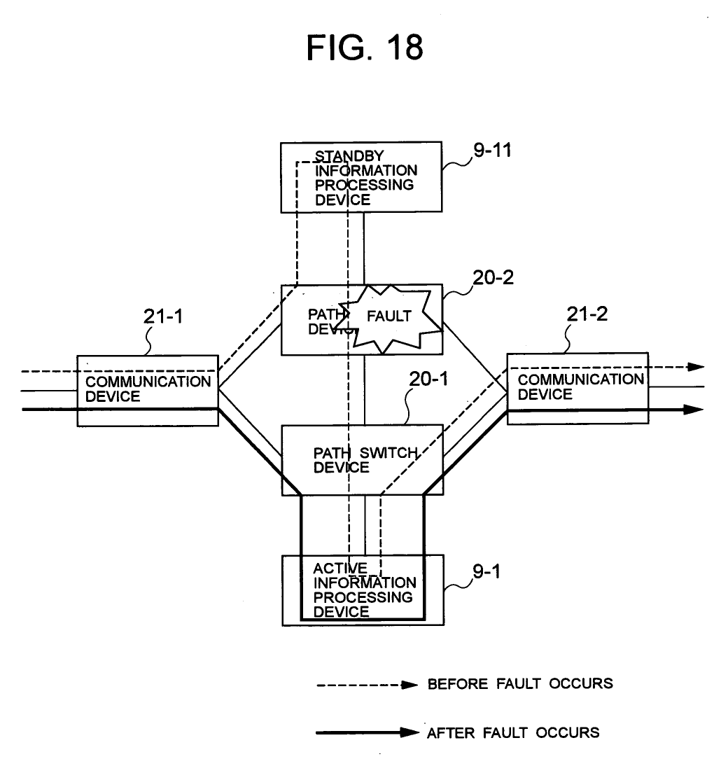

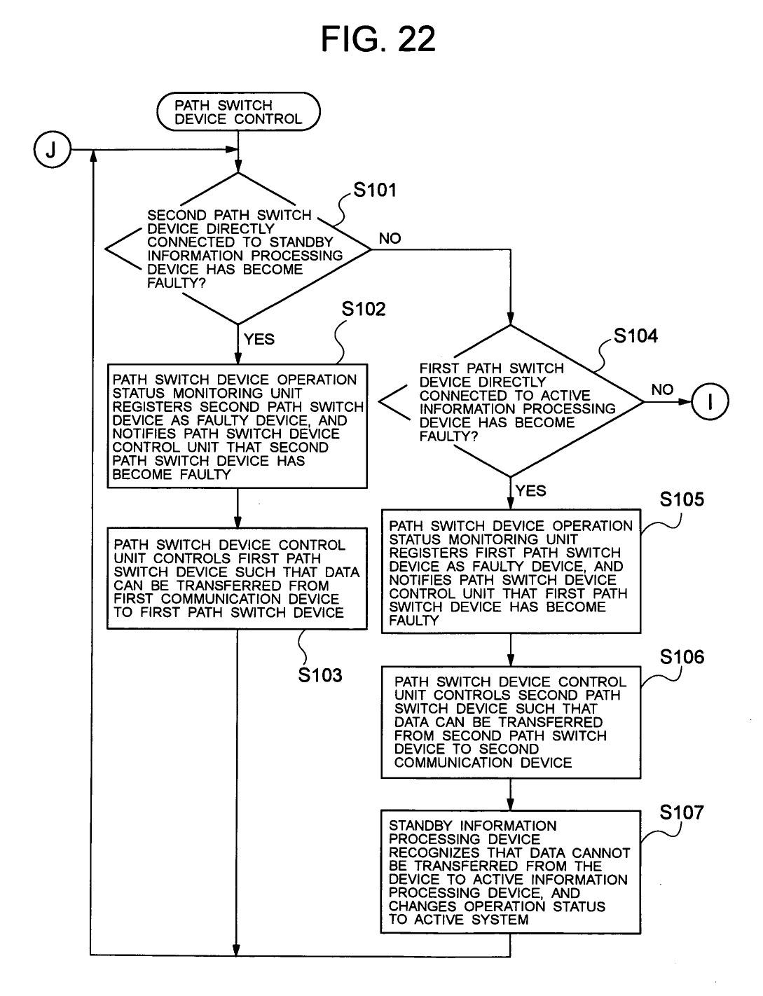

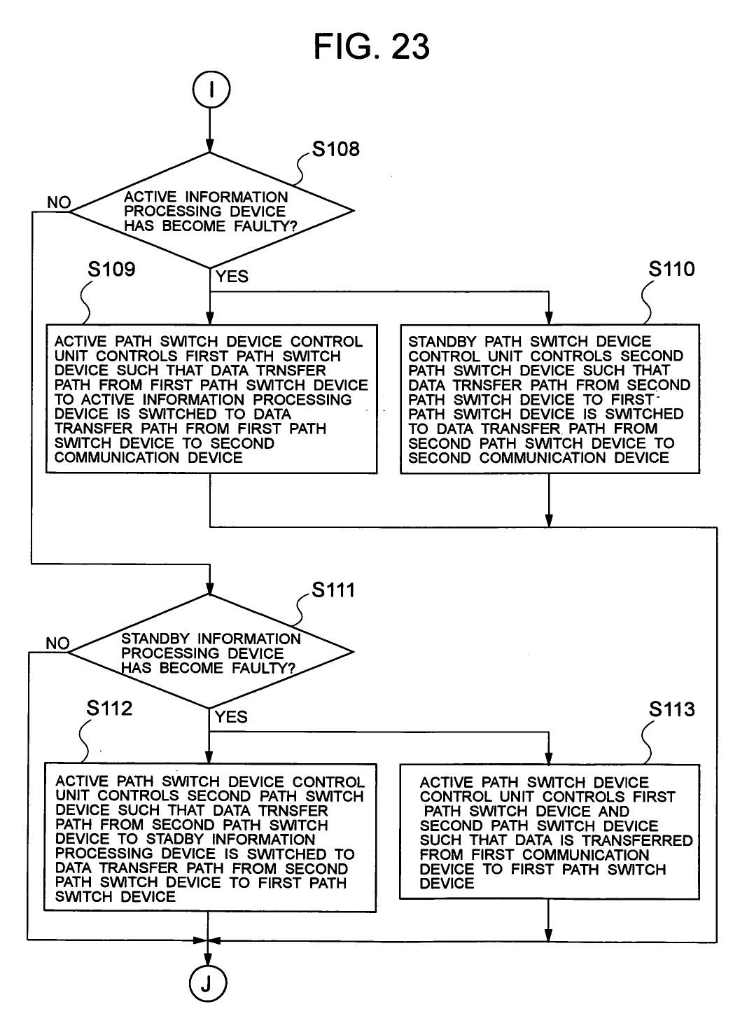

FIGS. 18 to 21 are explanatory views showing the operation of the information processing system according to the fourth example of the present invention. FIGS. 22 and 23 are flowcharts showing the operation of the information processing system according to the fourth example of the present invention. By referring to the FIGS. 16 to 23, the operation of the information processing system according to the fourth example of the present invention is explained. Since the information processing device 9 according to the fourth example of the present invention has many operations common with those according to the first example of the present invention, only the differences are explained below.

First, the communication path used when data is transferred from the transmitting terminal 2 to the receiving terminal 3 is explained. The data transmitted from the transmitting terminal 2 is transferred to the standby information processing device 9-11 through the first communication device 21-1 and the second path switch device 20-2. The standby information processing device 9-11 which has received the data transfers the data to the active information processing device 9-1 through the second path switch device 20-2 and the first path switch device 20-1. The active information processing device 9-1 which has received the data transfers the data to the second communication device 21-2. Afterwards, the data is transferred to an active information processing device through a standby information processing device similarly, and finally received by the receiving terminal 3.

Relating to the settings of the paths between the first communication devices 21-1, 21-3 and 21-5 and the second communication devices 21-2, 21-4 and 21-6, and between the first path switch devices 20-1, 20-3 and 20-5 and the second path switch devices 20-2, 20-4 and 20-6, the communication can be realized through the above-mentioned path by controlling each path switch device in the path switch device control unit 92.

The status monitor of the path switch device in the path switch device operation status monitoring unit 91 is explained below. The path switch device operation status monitoring unit 91 holds the information for identification of the first path switch device (20-1, 20-3, 20-5) directly connected to the standby information processing device, and the second path switch device (20-2, 20-4, 20-6) directly connected to the active information processing device, and monitors the respective operation statuses.

The active information processing device (9-1, 9-2, 9-3) transmits a monitor packet to the first path switch device (20-1, 20-3, 20-5) and the second path switch device (20-2, 20-4, 20-6). If there is no reply returned, or if there is a reply notifying that a fault has occurred, the first path switch device (20-1, 20-3, 20-5) and the second path switch device (20-2, 20-4, 20-6) are registered as faulty devices. The path switch device control unit 92 controls the path switch device depending on the operation statuses of the information processing device and the path switch device.

The operation of the information processing device performed when the path switch device becomes faulty is explained below. First, the case in which the second path switch device 20-2 directly connected to the standby information processing devices 9-11 becomes faulty is explained by referring to FIG. 18.

When the second path switch device 20-2 becomes faulty (step S101 shown in FIG. 22), the path switch device operation status monitoring unit 91 of each of the active information processing device 9-1 and the standby information processing device 9-11 registers the second path switch device 20-2 as a faulty device, and notifies the path switch device control unit 92 of the occurrence of the fault (step S102 shown in FIG. 22). Upon receipt of the notification that the second path switch device 20-2 has become faulty, the path switch device control unit 92 of each of the active information processing device 9-1 and the standby information processing device 9-11 controls the first path switch device 20-1 such that the data can be transferred from the first communication device 21-1 to the first path switch device 20-1 (step S103 shown in FIG. 22).

Relating to the control of the path switch device, when both active information processing device 9-1 and standby information processing devices 9-11 are in the operating state, control is performed by determining which performs control through the operation status monitoring units 16. The active information processing device 9-1 processes and transfers data as before the occurrence of the fault.

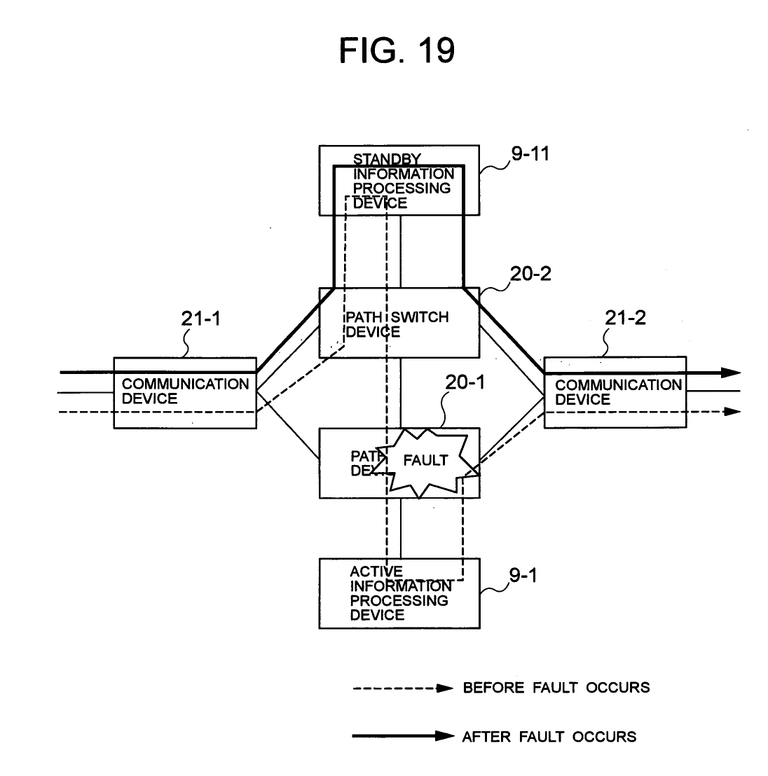

Next, the case in which the first path switch device 20-1 directly connected to the active information processing device 9-1 has become faulty is explained below by referring to FIG. 19. If it is determined that the first path switch device 20-1 has become faulty because the standby information processing device 9-11 cannot transfer data to the active information processing device 9-1 (step S104 shown in FIG. 22), the path switch device operation status monitoring unit 91 of each of the active information processing device 9-1 and the standby information processing device 9-11 registers the first path switch device 20-1 as a faulty device, and notifies the path switch device control unit 92 of the occurrence of the fault (step S105 shown in FIG. 22).

Upon receipt of the notification that the first path switch device 20-1 has become faulty, the path switch device control unit 92 of each of the active information processing device 9-1 and the standby information processing device 9-11 controls the second path switch device 20-2 such that the second path switch device 20-2 can transfer data to the second communication device 21-2 (step S106 shown in FIG. 22).

Relating to the control of the path switch device, when both active information processing device 9-1 and standby information processing device 9-11 are in the operating state, control is performed by determining which performs control through the operation status monitoring units 16. When the standby information processing device 9-11 recognizes that the first path switch device 20-1 is faulty, it recognizes that it cannot transfer data to the active information processing device 9-1, thereby changing the operation status of the device 9-11 to the active system (step S107 shown in FIG. 22).

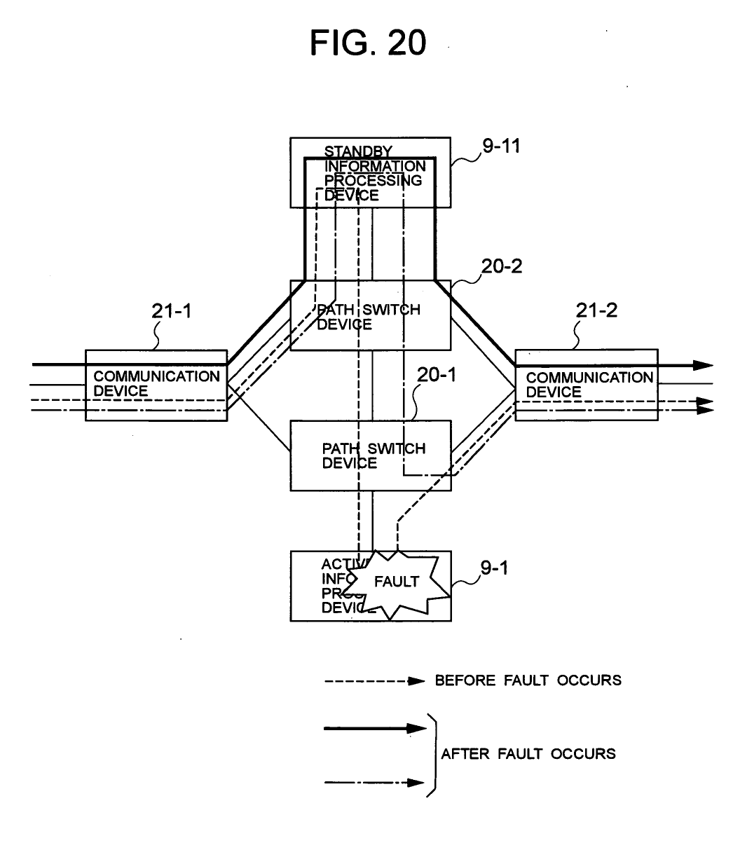

The case in which an information processing device becomes faulty is explained below by referring to the attached drawings. First, the case in which the active information processing device 9-1 becomes faulty is explained by referring to FIG. 20. As in the first example according to the present invention, the operation status monitoring unit 16 of the standby information processing device 9-11 registers the active information processing device 9-1 as a faulty device when a fault occurs in the active information processing device 9-1 (step S108 shown in FIG. 23), and changes the operation status of the device 9-11 to the active system.

The active information processing device 9-1 can pass the received data through to transfer the data to the second path switch device 20-2. With the case in which the function is lost taken into account, the path switch device control unit 92 for the active information processing device 9-1 controls the first path switch device 20-1 such that the path of the data transferred from the first path switch device 20-1 to the active information processing device 9-1 can be switched to the path of the data transferred from the first path switch device 20-1 directly to the second communication device 21-2 (step S109 shown in FIG. 23).

Otherwise, the path switch device control unit 92 for the standby information processing device 9-11 controls the second path switch device 20-2 such that the path of the data transferred from the second path switch device 20-2 to the first path switch device 20-1 can be switched to the path of the data transferred from the second path switch device 20-2 directly to the second communication device 21-2 (step S110 shown in FIG. 23).

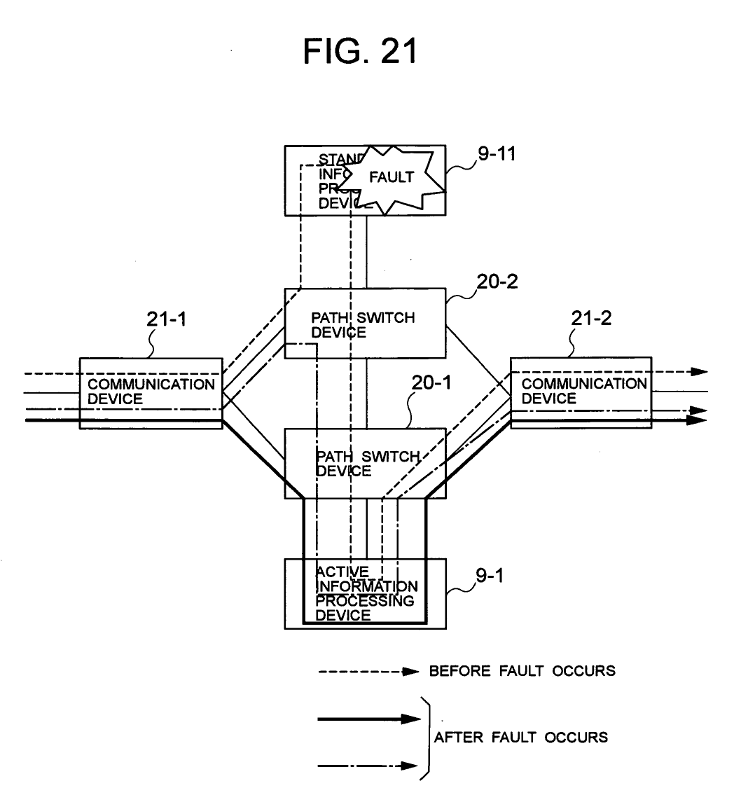

Next, the case in which the standby information processing device 9-11 has become faulty is explained below by referring to FIG. 21. As in the first example of the present invention, when the standby information processing device 9-11 becomes faulty (step S111 shown in FIG. 23), the operation status monitoring unit 16 of the active information processing device 9-1 registers the standby information processing device 9-11 as a faulty device.

It is possible that the standby information processing device 9-11 passes the received data through to transfer the data to the second path switch device 20-2. With the case in which the function is lost taken into account, the path switch device control unit 92 for the active information processing device 9-1 controls the second path switch device 20-2 such that the path of the data transferred from the second path switch device 20-2 to the standby information processing device 9-11 can be switched to the path of the data transferred from the second path switch device 20-2 to the first path switch device 20-1 (step S112 shown in FIG. 23).

Otherwise, the path switch device control unit 92 for the active information processing device 9-1 controls the first path switch device 20-1 and the second path switch device 20-2 such that the data can be transferred from the first communication device 21-1 to the first path switch device 20-1 (step S113 shown in FIG. 23). In the fourth example, the case in which an information processing device controls a path switch device to control the path has been explained. It is also possible to, for example, autonomously switch the path when the path switch device is an Ethernet switch.

Thus, in the fourth example, as in the above-mentioned first example of the present invention, a high-reliability information processing system can be realized. Furthermore, according to the fourth example, the reliability can be furthermore enhanced by duplicating the data transfer path to the subsequent stage.

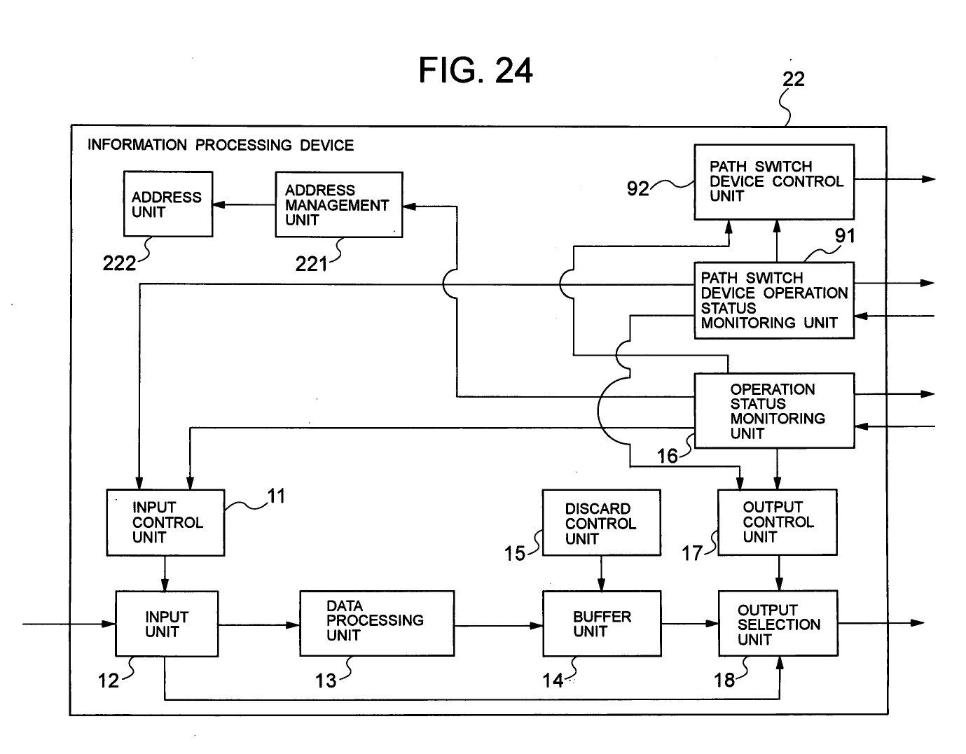

FIG. 24 is a block diagram of the configuration of the information processing device according to a fifth example of the present invention. In FIG. 24, an information processing device 22 according to the fifth example of the present invention has the same configuration as the information processing device 9 according to the fourth example of the present invention as shown in FIG. 16 except that an address management unit 221 and an address unit 222 are newly provided, and the same components are assigned the same reference numerals. The operations of the same components are similar to that according to the fourth example of the present invention. The address management unit 221 manages the address depending on the operation status of the information processing device 22, and the address unit 222 registers the address.

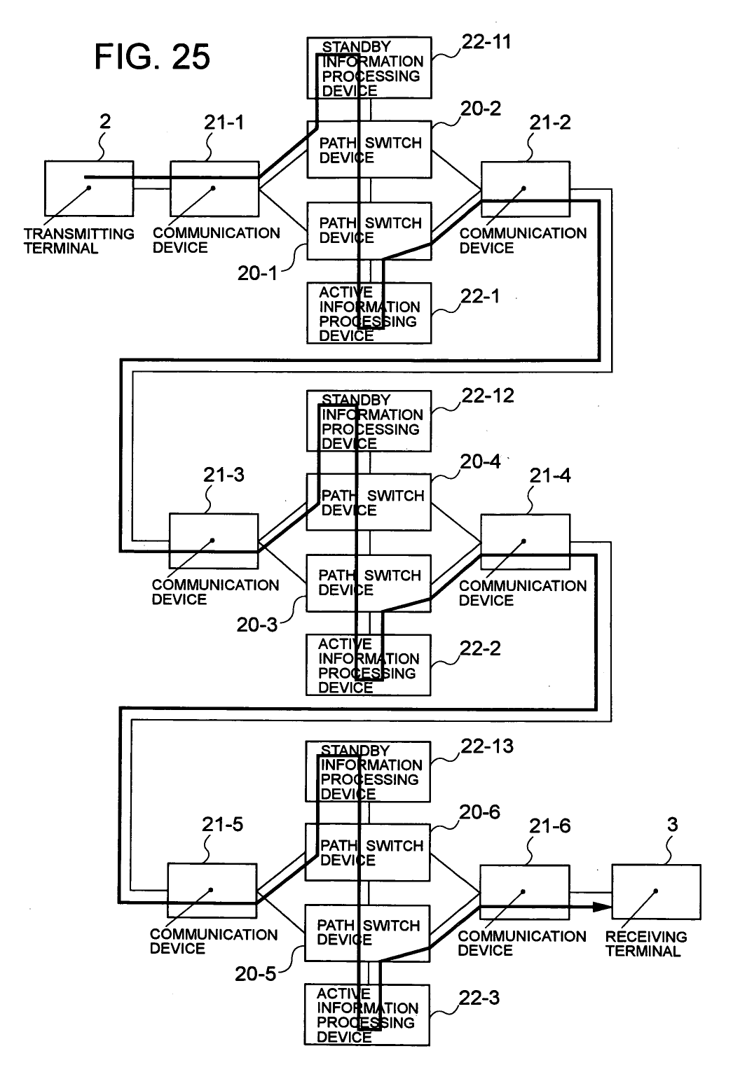

FIG. 25 is a block diagram of the configuration of the information processing system using the information processing device 22 shown in FIG. 24. In FIG. 25, the information processing system according to the fifth example of the present invention comprises the transmitting terminal 2, the receiving terminal 3, active information processing devices 22-1 to 22-3, standby information processing devices 22-11 to 22-13, the first path switch devices 20-1, 20-3, and 20-5, the second path switch devices 20-2, 20-4, and 20-6, the first communication devices 21-1, 21-3, and 21-5, and the second communication devices 21-2, 21-4, and 21-6. The active information processing devices 22-1 to 22-3 and the standby information processing devices 22-11 to 22-13 have the same configurations as that of the information processing device 22 shown in FIG. 24.

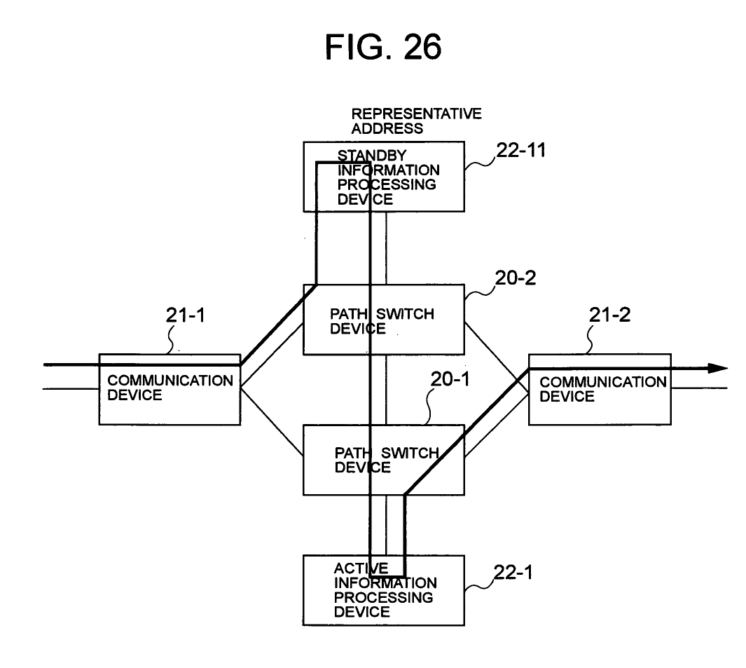

FIGS. 26 to 30 are explanatory views showing the operation of the information processing system according to the fifth example of the present invention. The operations of the information processing system according to the fifth example of the present invention are explained by referring to FIGS. 24 to 30. The operations of the information processing device 22 according to the fifth example of the present invention are common with those according to the fourth example of the present invention. Therefore, only the differences are explained below.

When the information processing device 22 has an IP (Internet protocol) address like a router, the information processing device 22 has addresses as the information for identifying each information processing device in the information processing system, the transmitting terminal 2, the receiving terminal 3, etc. The addresses are, for example, IP addresses. The address of the information processing device 22 is changed depending on the operation status.

Described below is the method of registering the above-mentioned address. As shown in FIG. 26, when both of the active information processing device 22-1 and the standby information processing device 22-11 are normally operated, the standby information processing device 22-11 registers a representative address. A representative address corresponds to an IP address of a gateway, etc. The active information processing device 22-1 registers an address other than the representative address.

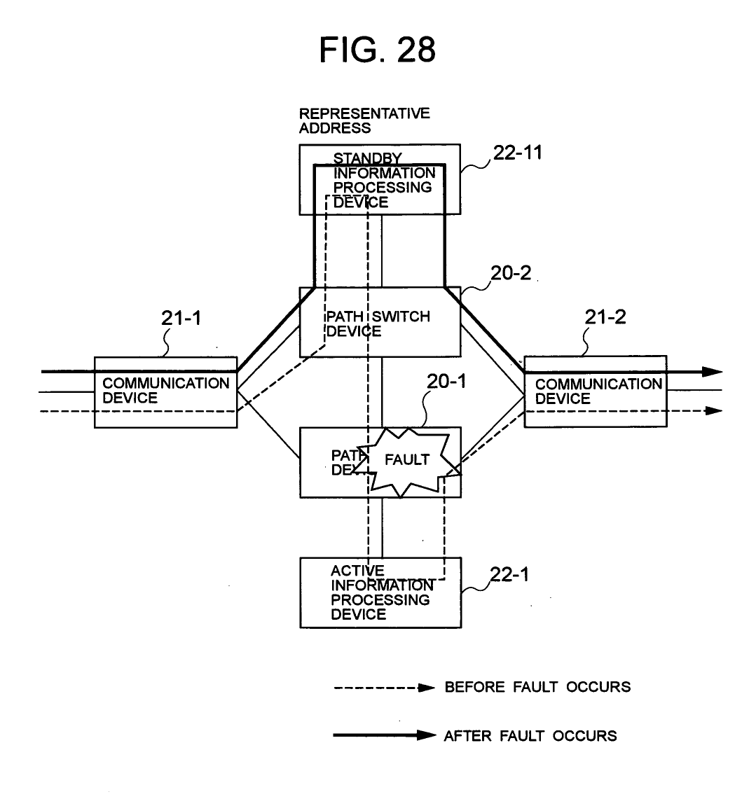

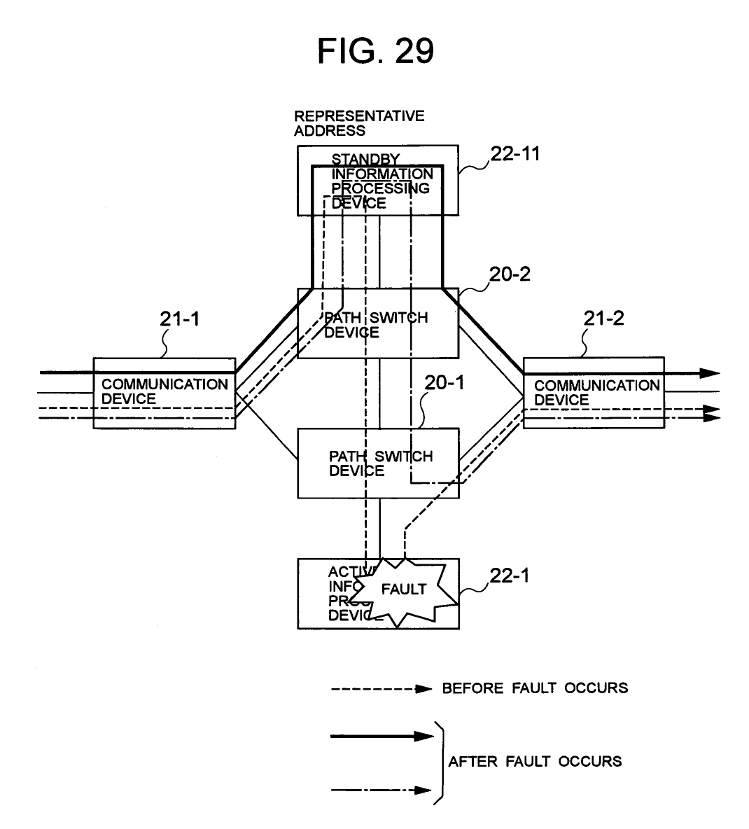

As shown in FIGS. 28 and 29, when the active information processing device 22-1 cannot function as an active information processing device due to the fault of the active information processing device 22-1 or the first path switch device 20-1 directly connected to the active information processing device 22-1, the standby information processing device 22-11 switches the operation status of the device 22-11 to the status of an active system, but the representative address is used as is without a change.

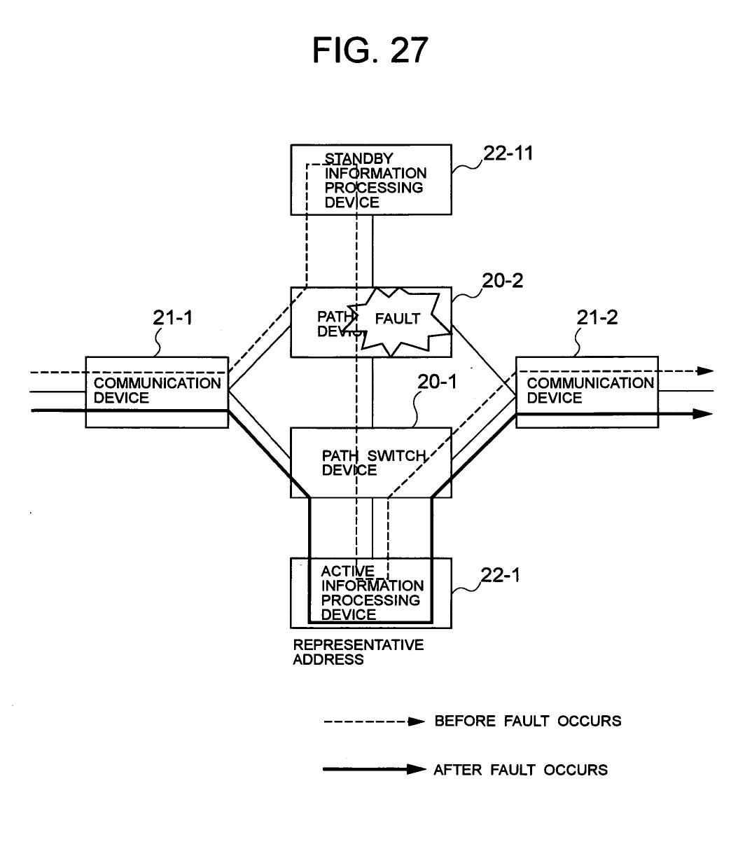

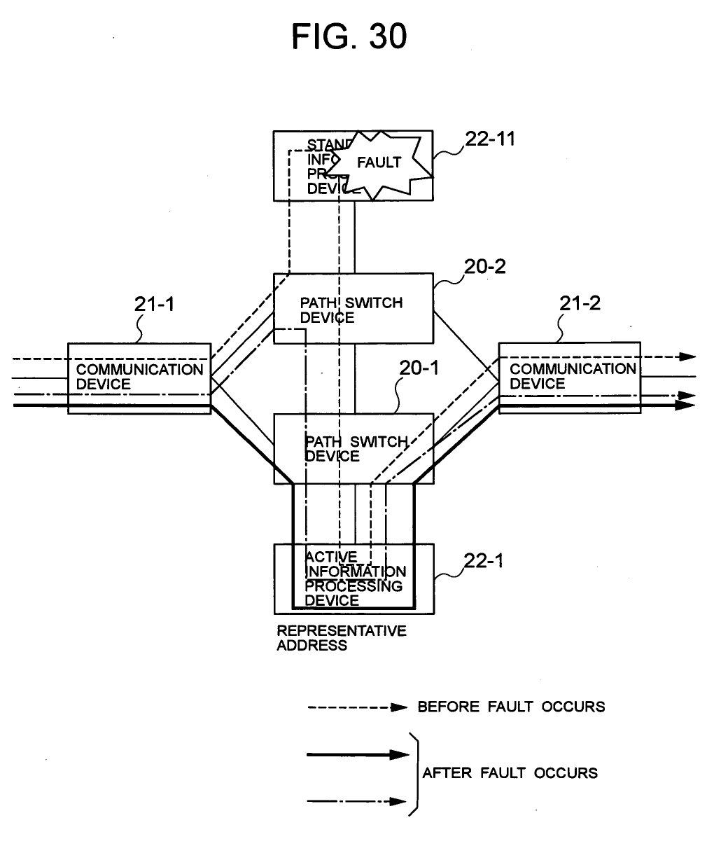

As shown in FIGS. 27 and 30, when the standby information processing device 22-11 cannot function as a standby information processing device due to the fault of the standby information processing device 22-11 or the second path switch device 20-2 directly connected to the standby information processing device 22-11, the active information processing device 22-1 registers as the address of the device 22-1 the representative address registered by the standby information processing device 22-11 for operation as an active information processing device.

Thus, according to the fifth example, as in the fourth example of the present invention, a high-reliability information processing system can be realized. Furthermore, according to the fifth example, when both an active information processing device and a standby information processing device are normally operated, a representative address is registered for the standby information processing device, thereby allowing the data transmitted from a transmitting terminal to be necessarily transmitted through the standby information processing device, and correctly controlling the path.

1-27. (canceled)

28. An information processing device forming a redundant system by an operation with a plurality of information processing devices, comprising:
operation status monitor means for monitoring operation statuses of the device and another device;
input means for receiving data;
buffer means for temporarily accumulating the data from the input means; and output selection means for selecting and outputting one of the data accumulated in the buffer means and the data directly input from the input means in accordance with the operation statuses of the device and the other device to be monitored by the operation status monitor means,
wherein the device is connected in series with each of the plurality of information processing devices.

29. An information processing device forming a redundant system by an operation as one of an active system and a standby system, the device comprising:
means for passing input data through to a subsequent stage when the device is operated as the standby system, wherein
the device is arranged before an information processing device operated as the active system when the device is operated as the standby system, and connected in series with the information processing device operated as the active system.

30. The information processing device according to claim 29, further comprising:
input means for receiving data;
buffer means for temporarily accumulating the data from the input means;
and selection means for selecting and outputting one of the data accumulated in the buffer means and the data directly input from the input means,
wherein the selection means selects and outputs the data accumulated in the buffer means when the device is operated as the active system, and selects and outputs the data directly input from the input means when the device is operated as the standby system.

31. The information processing device according to claim 30, wherein the device sequentially outputs data with oldest data accumulated in the buffer means to start with when the device is operated as the active system and detects a fault of an adjacent information processing device.

32. The information processing device according to claim 30, wherein the device is switched to the active system, and outputs the data accumulated in the buffer means when the device is operated as the standby system and detects a fault of an adjacent information processing device.

33. The information processing device according to claim 30, further comprising:
discard control means for discarding the data accumulated in the buffer means when the device is operated as the standby system.

34. The information processing device according to claim 33, wherein the discard control means discards the data when a predetermined time passes after the data is stored in the buffer means.

35. The information processing device according to claim 33, wherein the discard control means discards the data when a predetermined number of pieces or more of subsequent data are received in a session to which the data accumulated in the buffer means belongs.

36. The information processing device according to claim 33, wherein the discard control means sequentially discards the data with oldest data to start with when the buffer means is filled with the data.

37. The information processing device according to claim 33, further comprising:
acknowledgment reception means for monitoring an acknowledgment to the data output from the device,
wherein the discard control means discards the data accumulated in the buffer means in accordance with a monitor result of the acknowledgment reception means.

38. The information processing device according to claim 37, wherein the discard control means discards, in the data accumulated in the buffer means, data corresponding to the acknowledgment received by the acknowledgment reception means.

39. The information processing device according to claim 37, wherein the discard control means discards data accumulated in the buffer means before the data corresponding to the acknowledgment in a session to which the data corresponding to the acknowledgment belongs.

40. The information processing device according to claim 37, wherein the discard control means discards data accumulated in the buffer means a predetermined time before the data corresponding to the acknowledgment in a session to which the data corresponding to the acknowledgment belongs.

41. The information processing device according to claim 37, wherein the discard control means discards a predetermined amount of data older than the data corresponding to the acknowledgment in a session to which the data corresponding to the acknowledgment belongs.

42. The information processing device according to claim 37, wherein the acknowledgment reception means monitors the acknowledgment for each session to which the data belongs.

43. The information processing device according to claim 37, wherein the acknowledgment reception means monitors the acknowledgment for each session to which the data belongs at a predetermined time interval.

44. The information processing device according to claim 37, wherein the acknowledgment reception means monitors the acknowledgment at a predetermined rate for each session to which the data belongs.

45. The information processing device according to claim 37, further comprising:
acknowledgment transmission means for generating and transmitting an acknowledgment of the received data; and
acknowledgment output selection means for selecting whether or not the generated acknowledgment is to be output to a transmitter which transmits the received data, in accordance with the operation status of the device.

46. The information processing device according to claim 45, wherein the acknowledgment output selection means outputs the generated acknowledgment to the transmitter when the device is operated as the active system.

47. The information processing device according to claim 45, wherein the acknowledgment output selection means suppresses output of the generated acknowledgment to the transmitter when the device is operated as the standby system.

48. The information processing device according to claim 45, wherein the acknowledgment output selection means outputs the generated acknowledgment to the transmitter when the device is operated as the standby system and detects a fault of an adjacent information processing device.

49. The information processing device according to claim 45, wherein the device re-transmits data including data already transmitted from the information processing device when detecting a fault in an adjacent information processing device.

50. The information processing device according to claim 29, wherein in a pair of information processing devices closest to a transmitter, the device operated as the standby system is arranged closer to the transmitter than the device operated as the active system, in a pair of information processing devices closest to a receiver, the device operated as the standby system is arranged closer to the receiver than the device operated as the active system, and the devices are connected in series.

51. The information processing device according to claim 29, wherein the information processing device operated as the standby system switches an operation status of the device to an active system when a data transfer to an information processing device operated as the active system is impossible while the information processing device operated as the active system is operating.

52. The information processing device according to claim 29, wherein when the information processing device operated as the active system and the information processing device operated as the standby system are both normally operating, the information processing device operated as the standby system has a representative address as an address of the device.

53. The information processing device according to claim 29, wherein when the information processing device operated as the active system and the information processing device operated as the standby system are both normally operating, the information processing device operated as the active system has an address other than a representative address as an address of the device.

54. The information processing device according to claim 52, wherein when the information processing device operated as the active system recognizes that the information processing device operated as the standby system becomes faulty and that the information processing device operated as the standby system cannot be used, the device has the representative address as an address of the device.

55. An information processing method used for an information processing system having a redundant configuration by operating a plurality of information processing devices, wherein:
the information processing device monitors operation statuses of the device and another device, receives data by input means for receiving data, and selects and outputs one of data accumulated in buffer means for temporarily accumulating the data from the input means and the data directly input from the input means in accordance with the operation statuses of the device and the other device to be monitored; and
the plurality of information processing devices are connected in series.

56. An information processing method used for an information processing system having a redundant configuration by operating a plurality of information processing devices as an active system and a standby system, wherein:
the information processing device performs a process of passing input data through to a subsequent stage when the device is operated as the standby system; and
the information processing device operated as the standby system is arranged before the information processing device operated as the active system, and the devices are connected in series.

57-84. (canceled)
